(19) United States
(12) Patent Application Publication
(10) Pub. No.: US 2005/0254498 A1
(43) Pub. Date: Nov. 17, 2005

(54) Data processing device

(76) Inventor: Masanori Itoh, Osaka (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 10/520,548

(22) PCT Filed: Jul. 11, 2003
(86) PCT No.: PCT/JP03/08872

§ 371 Date: Jan. 6, 2005

(30) Foreign Application Priority Data
Jul. 12, 2002 (JP) 2002-203837
Sep. 2, 2002 (JP) 2002-256752

(51) Int. Cl. H04L 12/28

(52) U.S. Cl. 370/394

(57) ABSTRACT

A data processor according to the present invention includes receiving sections 100, 102 for receiving video data and audio data, a compressing section 101 for generating encoded data, complying with the MPEG-2 system standard, by encoding the video and audio data received, an auxiliary information generating section 103 for generating auxiliary information, which includes reference information to make reference to the encoded data and attribute information that uses a VOBU of the encoded data as a sample unit and that describes an attribute of the sample unit, and a writing section 120 for writing the encoded data and the auxiliary information on a storage medium as a data file and an auxiliary information file, respectively. The encoded data is decodable by either the auxiliary information file or the MPEG-2 system standard.

### TECHNICAL FIELD

The present invention relates to a data processor and processing method for writing stream data of a moving picture stream on a storage medium such as an optical disc.

### BACKGROUND ART

Various types of data streams have been standardized to compress and encode video data at low bit rates. A system stream compliant with the MPEG-2 system standard (ISO/IEC 13818-1) is known as one such data stream. There are three types of system streams, namely, a program stream (PS), a transport stream (TS) and a PES stream.

Recently, another data stream, complying with the MPEG-4 system standard (ISO/IEC 14496-1), has been being defined. In a format compliant with the MPEG-4 system standard, video streams, including MPEG-2 or MPEG-4 video streams, and various types of audio streams are multiplexed together, thereby generating moving picture stream data. Furthermore, according to a format compliant with the MPEG-4 system standard, auxiliary information is defined. The auxiliary information and a moving picture stream are defined as a single file (which is called an “MP4 file”). The data structure of an MP4 file is based on, and an extension of, a QuickTime® file format of Apple Corporation. It should be noted that as for a system stream compliant with the MPEG-2 system standard, no data structure storing the auxiliary information (such as access information, special playback information and recording date) is defined. This is because the auxiliary information is included in a system stream according to the MPEG-2 system standard.

Video data and audio data would often be recorded on a magnetic tape in the past. Recently, however, optical discs such as DVD-RAMs and MOs have attracted much attention as storage media that will soon replace magnetic tapes.

FIG. 1 shows a configuration for a conventional data processor 350. The data processor 350 can read and write a data stream from/on a DVD-RAM disc. The data processor 350 receives a video data signal at a video signal input section 300 and an audio data signal at an audio signal input section 302, respectively, and sends them to an MPEG-2 compressing section 301. The MPEG-2 compressing section 301 compresses and encodes the video data and audio data in accordance with the MPEG-2 standard and/or the MPEG-4 standard, thereby generating an MP4 file. More specifically, the MPEG-2 compressing section 301 compresses and encodes the video data and audio data in accordance with the MPEG-2 Video standard to generate a video stream and an audio stream. Thereafter, the MPEG-2 compressing section 301 further multiplexes these streams together in accordance with the MPEG-4 system standard, thereby generating an MP4 file. In this case, a writing control section 341 controls the operation of a writing section 320. In accordance with an instruction given by the writing control section 341, a continuous data area detecting section 340 checks the availability of sectors being managed by a logical block management section 343, thereby detecting physically continuous unused areas. Then, the writing section 320 gets the MP4 file written on the DVD-RAM disc 331 by a pickup 330.

FIG. 2 shows the data structure of an MP4 file 20. The MP4 file 20 includes auxiliary information 21 and a moving picture stream 22. The auxiliary information 21 is described by an atom structure 23 defining the attributes of video data, audio data and so on. FIG. 3 shows a specific example of the atom structure 23. In the atom structure 23, the data size (on a frame basis), the address of the data storage location, a time stamp showing the playback timing and other pieces of information are described for each of the video data and audio data. This means that the video data and audio data are managed as individual track atoms.

In the moving picture stream 22 of the MP4 file shown in FIG. 2, the video data and audio data are each arranged on a frame basis, thereby making up a stream. For example, if the moving picture stream has been obtained by the compression coding method compliant with the MPEG-2 standard, then a plurality of GOPs are defined for the moving picture stream. A GOP is a unit for a collection of video frames including an I-picture, which is a video frame that can be read by itself, and P- and B-pictures that are interposed between one I-picture and the next I-picture. In reading an arbitrary video frame of the moving picture stream 22, first, a GOP including that video frame is identified in the moving picture stream 22.

It should be noted that a data stream with a structure including a moving picture stream and auxiliary information as in the data structure of the MP4 file shown in FIG. 2 will be referred to herein as an “MP4 stream”.

FIG. 4 shows the data structure of a moving picture stream 22. The moving picture stream 22 includes a video track and an audio track, to each of which an identifier TrackID is added. Not every moving picture stream includes one track apiece but the tracks may sometimes be changed. FIG. 5 shows a moving picture stream 22 in which the tracks are changed on the way.

FIG. 6 shows a correlation between a moving picture stream 22 and storage units (i.e., sectors) of the DVD-RAM disc 331. The writing section 320 writes the moving picture stream 22 on the DVD-RAM disc in real time. More specifically, the writing section 320 secures a logical block, which is physically continuous for at least 11 seconds when converted at the maximum write rate, as a single continuous data area and sequentially writes video and audio frames there. The continuous data area consists of a plurality of logical blocks, each of which has a size of 32 kilobytes and to each of which an error correction code is added. Each logical block is further made up of a plurality of sectors, each having a size of 2 kilobytes. The continuous data area detecting section 340 of the data processor 350 detects again the next continuous data area when the remainder of the single continuous data area becomes less than 3 seconds, for example, if converted at the maximum write rate. When the single continuous data area is full, the continuous data area detecting section 340 writes the moving picture stream on the next continuous data area. The auxiliary information 21 of the MP4 file 20 is also written on the continuous data area that has been secured in a similar manner.

FIG. 7 shows how the written data is managed by the file system of the DVD-RAM. In this case, either a file system compliant with the universal disk format (UDF) standard or a file system compliant with ISO/IEC 13346 (Volume and File Structure of Write-Once and Rewritable Media Using Non-Sequential Recording for Information Interchange) may be used. In FIG. 7, the continuously written MP4 file is stored under the file name “MOV0001.MP4”. The file name and file entry location of this file are managed by a file identifier descriptor (FID). The file name is defined as MOV0001.MP4 in the file identifier, while the file entry location is defined by the top sector number of the file entry in the ICB.

It should be noted that the UDF standard corresponds to the installing terms of the ISO/IEC 13346 standard. By connecting a DVD-RAM drive to a computer such as a PC by way of a 1394 interface and a serial bus protocol 2 (SBP-2), the PC can also treat a file that was written in a UDF compliant format as a single file.

y using allocation descriptors, the file entry manages the continuous data areas (CDAs) a, b, c and the data area d where the data is stored. More specifically, if the writing control section 341 finds a defective logical block while writing the MP4 file on the continuous data area a, then the writing control section 341 will skip that defective logical block and continue to write the file from the beginning of the continuous data area b. Next, if the writing control section 341 finds a non-writable PC file storage area while writing the MP4 file on the continuous data area b, then the writing control section 341 will resume writing the file from the beginning of the continuous data area c. On having written the file, the writing control section 341 will write the auxiliary information 21 on the data area d. As a result, the file VR_MOVIE.VRO is made up of the continuous data areas a, b, c and d.

As shown in FIG. 7, the beginning of the data to be referenced by the allocation descriptor a, b, c or d matches with the top of its associated sector. Also, the data to be referenced by every allocation descriptor a, b or c, except the last allocation descriptor d, has a data size that is an integral number of times as large as that of one sector. Such a description rule is defined in advance.

In playing back an MP4 file, the data processor 350 retrieves and receives a moving picture stream by way of the pickup 330 and a reading section 321 and gets the stream decoded by an MPEG-2 decoding section 311, thereby generating a video signal and an audio signal, which are eventually output through a video signal output section 310 and an audio signal output section 312, respectively. Reading the data from the DVD-RAM disc and outputting the read data to the MPEG-2 decoding section 311 are carried out concurrently. In this case, the data read rate is set higher than the data output rate and is controlled such that the data to be played back does not run short. Accordingly, if the data is continuously read and output, then extra data can be obtained by the difference between the data read rate and the data output rate. By using that extra data as the data to be output while data reading is discontinued by pickup's jump, continuous playback is realized.

Specifically, supposing the rate of reading the data from the DVD-RAM disc 331 is 11 Mbps, the maximum rate of outputting the data to the MPEG-2 decoding section 311 is 8 Mbps and the longest time it takes to move the pickup is 3 seconds, data of 24 megabits, which corresponds with the amount of data to be output to the MPEG-2 decoding section 311 while the pickup is moving, is needed as the extra output data. To secure this amount of data, the data needs to be read for eight seconds on end. That is to say, the continuous reading needs to last for the amount of time that is obtained by dividing 24 megabits by the difference between the data read rate of 11 Mbps and the data output rate of 8 Mbps.

Accordingly, while the continuous reading is carried out for eight seconds, data of 88 megabits, which should be output in eleven seconds, is read out. Thus, if a continuous data area with a size corresponding to at least eleven seconds is secured, then continuous data playback can be guaranteed.

It should be noted that several defective logical blocks may be included within the continuous data area. In that case, however, the continuous data area needs to have a size corresponding to an amount of time that is slightly longer than eleven seconds with the expected read time, which it will take to read those defective logical blocks during the playback operation, taken into account.

In performing the process of deleting a stored MP4 file, the writing control section 341 performs predetermined deletion processing by controlling the writing section 320 and reading section 321. In the MP4 file, the auxiliary information includes presentation timings (i.e., time stamps) of all frames. Accordingly, in partially deleting an intermediate portion of a moving picture stream, only the time stamps in the auxiliary information need to be deleted. It should be noted that in an MPEG-2 system stream, the moving picture stream should be analyzed to ensure continuity even at the partially deleted portion. This is because the time stamps are dispersed over the stream.

The MP4 file format is characterized by storing the video frames or audio frames of a video/audio stream as a single set. At the same time, the MP4 file format defines access information, which enables random access to any arbitrary frames, for the first time ever for any international standard defined so far. The access information is defined on a frame-by-frame basis, and may include the frame size, frame period, and address information for a frame. More specifically, the access information is stored for every unit (e.g., every display period of 1/30 second for a video frame and every 1,536 samples for an audio frame (in AC-3 audio, for example)). Accordingly, if the presentation timing of a video frame needs to be changed, only the access information thereof should be changed, and the video/audio stream does not always have to be changed. The access information of that type has a data size of about 1 megabyte per hour.

As to the data size of the access information, according to “DVD Standard Part III for Rewritable/rerecordable discs: Video Recording Standard Version 1.1”, issued by DVD Forum, VR4, pp. 31-35, the access information compliant with the DVD Video recording standard needs to have a data size of 70 kilobytes per hour. The data size of the access information as defined by the DVD Video recording standard is less than one-tenth of that of the access information included in the auxiliary information of an MP4 file. FIG. 8 schematically shows a correlation between the field names used as the access information compliant with the DVD Video recording standard and pictures represented by the field names. FIG. 9 shows the data structure of the access information shown in FIG. 8, the field names defined for the data structure, and their contents and data sizes.

Also, the optical disc drive disclosed in Japanese Patent Application Laid-Open Publication No. 2001-94933 (see FIG. 3, among other things) not only writes video frames on a GOP basis, not on a frame basis, but also writes each audio frame continuously for a period of time corresponding to one GOP. The optical disc drive defines the access information on a GOP basis, too, thereby cutting down the required data size of the access information.

Furthermore, the MP4 file describes a moving picture stream in accordance with the MPEG-2 Video standard but is not compatible with a system stream as defined by the MPEG-2 system standard. Thus, the MP4 file cannot be edited by utilizing the moving picture editing capability of any application used extensively today on PCs, for example. This is because the editing capability of a lot of applications is targeted on a moving picture stream compliant with the MPEG-2 system standard. Furthermore, the MP4 file standard defines no decoder model to ensure playback compatibility for a moving picture stream portion. Then, absolutely no piece of software or hardware compliant with the MPEG-2 system standard, which has circulated very widely today, can be used at all.

### DISCLOSURE OF INVENTION

An object of the present invention is to provide a data structure, of which the access information has a small data size and which can be used even in an application designed for a conventional format, and also provide a data processor that can perform processing based on such a data structure.

A data processor according to the present invention includes: a receiving section for receiving video data and audio data; a compressing section for generating encoded data, complying with the MPEG-2 system standard, by encoding the video data and audio data received; an auxiliary information generating section for generating auxiliary information, which includes reference information to make reference to the encoded data and attribute information that uses a video object unit (VOBU) of the encoded data as a sample unit and that describes an attribute of the sample unit; and a writing section for writing the encoded data and the auxiliary information on a storage medium as a data file and an auxiliary information file, respectively. The encoded data is decodable by either the auxiliary information file or the MPEG-2 system standard.

In one preferred embodiment, the reference information represents the file name and storage location of the data file stored on the storage medium.

In another preferred embodiment, the compressing section generates the encoded data as a plurality of sets, and the auxiliary information generating section generates the reference information that makes reference to the respective encoded data.

In another preferred embodiment, the compressing section generates the encoded data as a plurality of sets, and the auxiliary information generating section generates stream data as a single stream by arranging the plurality of sets of encoded data as a series, and also generates auxiliary information that further describes location information specifying the storage location of the encoded data if the data size of the encoded data is not constant every time the data is read.

In another preferred embodiment, the compressing section generates the encoded data as either an MPEG-2 program stream or an MPEG-2 transport stream.

In another preferred embodiment, the auxiliary information generating section describes an audio frame of encoded audio data, representing the audio data of the encoded data, as another sample unit in the attribute information.

In another preferred embodiment, the compressing section generates first, second and third data files, and the second data file includes frame data that is needed to decode the encoded data of the first and third data files continuously with no time gap left.

In another preferred embodiment, the auxiliary information generating section generates an auxiliary information file that is described in the MP4 format.

In another preferred embodiment, the auxiliary information generating section generates an auxiliary information file that is described in the QuickTime format.

Stream data according to the present invention is made up of encoded data included in a data file and auxiliary information included in an auxiliary information file. The encoded data is obtained by encoding video data and audio data in accordance with the MPEG-2 system standard, and is decodable by either the auxiliary information or the MPEG-2 system standard. The auxiliary information includes: reference information to make reference to the encoded data; and attribute information that uses a video object unit (VOBU) of the encoded data as a sample unit and that describes an attribute of the sample unit. This stream data is stored on a storage medium according to the present invention.

Another data processor according to the present invention includes: a reading section for reading the auxiliary information file from the stream data and also reading the data file in response to a control signal; a reading control section for generating, as the control signal, a signal instructing that the data file be read in accordance with the reference information defined by the auxiliary information of the auxiliary information file; a decoding section, which receives the encoded data from the data file read and the auxiliary information and which decodes the encoded data into the video data and the audio data in accordance with the attribute information included in the auxiliary information; and an output section for outputting the video and audio data decoded.

A data writing method according to the present invention includes steps of: receiving video data and audio data; generating encoded data, complying with the MPEG-2 system standard, by encoding the video data and audio data received; generating auxiliary information, which includes reference information to make reference to the encoded data and attribute information that uses a video object unit (VOBU) of the encoded data as a sample unit and that describes an attribute of the sample unit; and writing the encoded data and the auxiliary information on a storage medium as a data file and an auxiliary information file, respectively. The encoded data is decodable by either the auxiliary information file or the MPEG-2 system standard.

A data writing program according to the present invention is a computer program to be executed by a data processor. The data writing program includes steps of: receiving video data and audio data; generating encoded data, complying with the MPEG-2 system standard, by encoding the video data and audio data received; generating auxiliary information, which includes reference information to make reference to the encoded data and attribute information that uses a video object unit (VOBU) of the encoded data as a sample unit and that describes an attribute of the sample unit; and writing the encoded data and the auxiliary information on a storage medium as a data file and an auxiliary information file, respectively. The encoded data is decodable by either the auxiliary information file or the MPEG-2 system standard.

A data reading method according to the present invention includes steps of: reading the auxiliary information file from the stream data; generating a control signal instructing that the data file be read in accordance with the reference information defined by the auxiliary information of the auxiliary information file; reading the data file in response to the control signal; receiving the encoded data from the data file read and the auxiliary information and decoding the encoded data into the video data and the audio data in accordance with the attribute information included in the auxiliary information; and outputting the video and audio data decoded.

A data reading program according to the present invention is a computer program to be executed by a data processor. The data reading program includes steps of: reading the auxiliary information file from the stream data; generating a control signal instructing that the data file be read in accordance with the reference information defined by the auxiliary information of the auxiliary information file; reading the data file in response to the control signal; receiving the encoded data from the data file read and the auxiliary information and decoding the encoded data into the video data and the audio data in accordance with the attribute information included in the auxiliary information; and outputting the video and audio data decoded.

Still another data processor according to the present invention includes: a receiving section for receiving video data and audio data; a compressing section, which encodes the received video and audio data by a predetermined encoding technique, thereby generating encoded data in which data representing the video data and data representing the audio data are interleaved with each other; and an auxiliary information generating section for generating auxiliary information, which includes reference information to make reference to the encoded data and attribute information that describes an attribute of a sample unit. The sample is a set of the encoded data that has been collected according to a playback duration of the video data. The encoded data is decodable by either the auxiliary information or a decoding technique corresponding to the predetermined encoding technique.

### BRIEF DESCRIPTION OF DRAWINGS

FIG. 1 shows a configuration for a conventional data processor 350.

FIG. 2 shows the data structure of an MP4 file 20.

FIG. 3 shows a specific example of the atom structure 23.

FIG. 4 shows the data structure of a moving picture stream 22.

FIG. 5 shows a moving picture stream 22 in which tracks are changed on the way.

FIG. 6 shows a correlation between a moving picture stream 22 and sectors of a DVD-RAM disc 331.

FIG. 7 shows how the written data is managed by the file system of the DVD-RAM.

FIG. 8 schematically shows a correlation between the field names used as the access information compliant with the DVD Video recording standard and pictures represented by the field names.

FIG. 9 shows the data structure of the access information shown in FIG. 8, the field names defined for the data structure, and their contents and data sizes.

FIG. 10 illustrates a connection environment for a portable videocorder 10-1, a movie recorder 10-2 and a PC 10-3 for carrying out the data processing of the present invention.

FIG. 11 shows an arrangement of functional blocks in a data processor 10.

FIG. 12 shows the data structure of an MP4 stream 12 according to the present invention.

FIG. 13 shows the management unit of audio data in an MPEG2-PS 14.

FIG. 14 shows a correlation between a program stream and elementary streams.

FIG. 15 shows the data structure of auxiliary information 13.

FIG. 16 shows the contents of respective atoms that make up an atom structure.

FIG. 17 shows a specific exemplary description format for “Data Reference Atom” 15.

FIG. 18 shows specific exemplary descriptions of respective atoms included in “Sample Table Atom” 16.

FIG. 19 shows a specific exemplary description format for “Sample Description Atom” 17.

FIG. 20 shows the contents of respective fields of “sample_description_entry” 18.

FIG. 21 is a flowchart showing a procedure to generate the MP4 stream.

FIG. 22 is a table showing the differences between the MPEG2-PS generated by the processing of the present invention and a conventional MPEG-2 Video (elementary stream).

FIG. 23 shows the data structure of the MP4 stream 12 in a situation where one VOBU is handled as one chunk.

FIG. 24 shows the data structure in the situation where one VOBU is handled as one chunk.

FIG. 25 shows specific exemplary descriptions of respective atoms included in Sample Table Atom 19 in the situation where one VOBU is handled as one chunk.

FIG. 26 shows an exemplary MP4 stream 12 in which two PS files are provided for a single auxiliary information file.

FIG. 27 shows an example in which there are a number of discontinuous MPEG2-PS's within one PS file.

FIG. 28 shows an MP4 stream 12 in which a PS file, storing an MPEG2-PS for the purpose of seamless connection, is provided.

FIG. 29 shows the audio frame that is absent from the discontinuity point.

FIG. 30 shows the data structure of an MP4 stream 12 according to another example of the present invention.

FIG. 31 shows the data structure of an MP4 stream 12 according to still another example of the present invention.

FIG. 32 shows the data structure of an MTF file 32.

FIG. 33 shows a correlation among various types of file format standards.

FIG. 34 shows the data structure of a QuickTime stream.

FIG. 35 shows the contents of respective atoms in the auxiliary information 13 of the QuickTime stream.

FIG. 36 shows the contents of flags defined for a moving picture stream in a situation where the number of recording pixels changes.

### BEST MODE FOR CARRYING OUT THE INVENTION

Hereinafter, preferred embodiments of the present invention will be described with reference to the accompanying drawings.

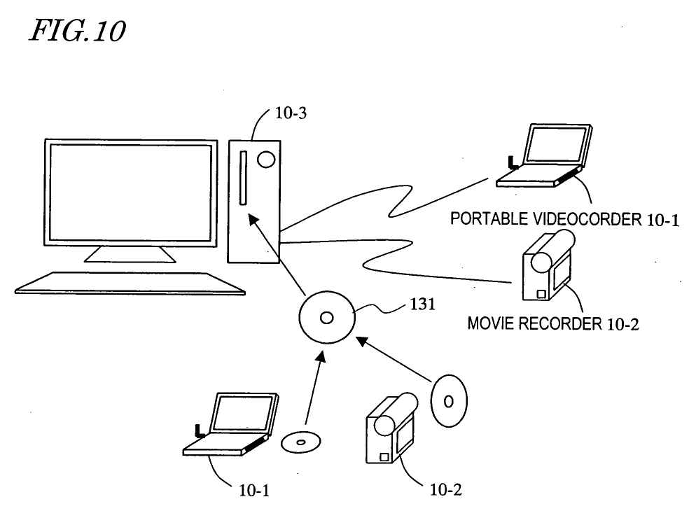

FIG. 10 illustrates how to connect a portable videocorder 10-1, a movie recorder 10-2 and a PC 10-3 for carrying out the data processing of the present invention.

The portable videocorder 10-1 receives a broadcast program via its attached antenna and compresses the moving pictures of the broadcast program, thereby generating an MP4 stream. The movie recorder 10-2 records not only video but also its accompanying audio, thereby generating another MP4 stream. In an MP4 stream, the video and audio data are encoded by a predetermined compression coding method and are described in accordance with the data structure of the present invention. The portable videocorder 10-1 and movie recorder 10-2 either store the generated MP-4 streams on a storage medium 131 such as a DVD-RAM or output the streams through a digital interface such as an IEEE 1394 or USB port. It should be noted that the portable videocorder 10-1 and movie recorder 10-2 needs to have even smaller sizes. Thus, the storage medium 131 does not have to be an optical disc with a diameter of 8 cm but may be an optical disc with a smaller diameter, for example.

The PC 10-3 receives the MP4 streams by way of either the storage medium or a transmission medium. If the respective appliances are connected together through a digital interface, then the PC 10-3 can receive the MP4 streams from the respective appliances by controlling the movie recorder 10-2 and so on as external storage devices.

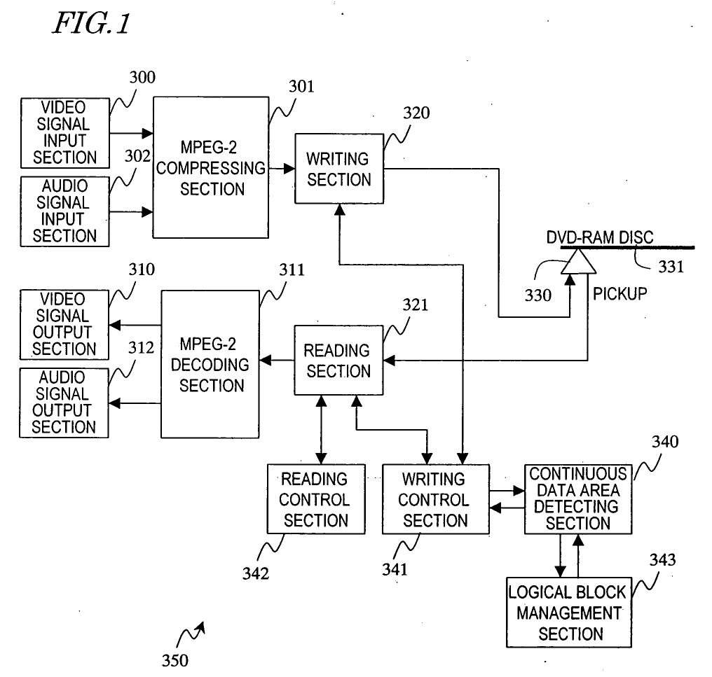

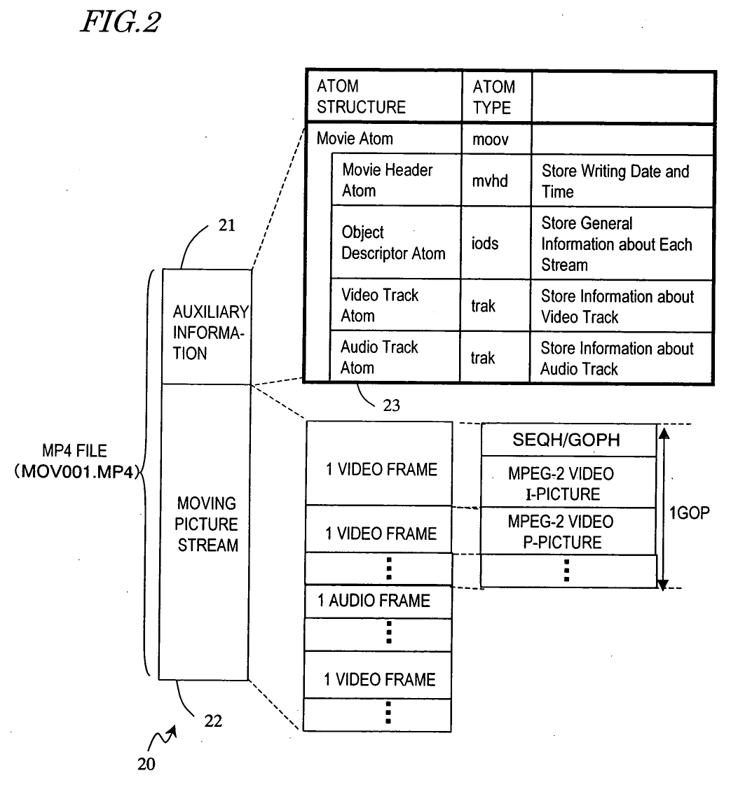

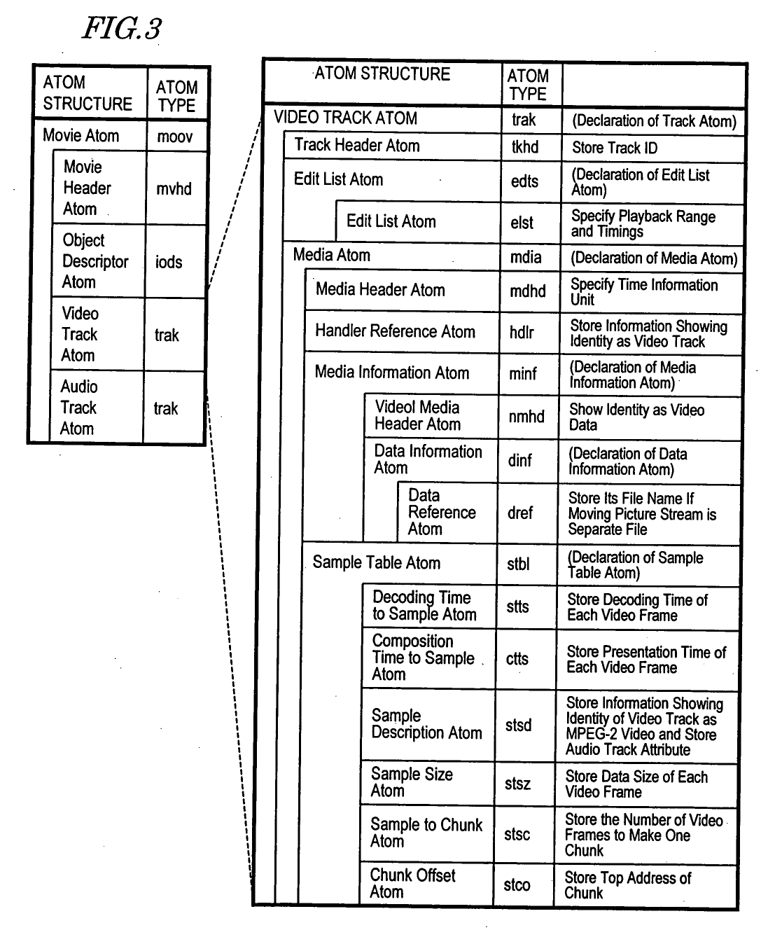

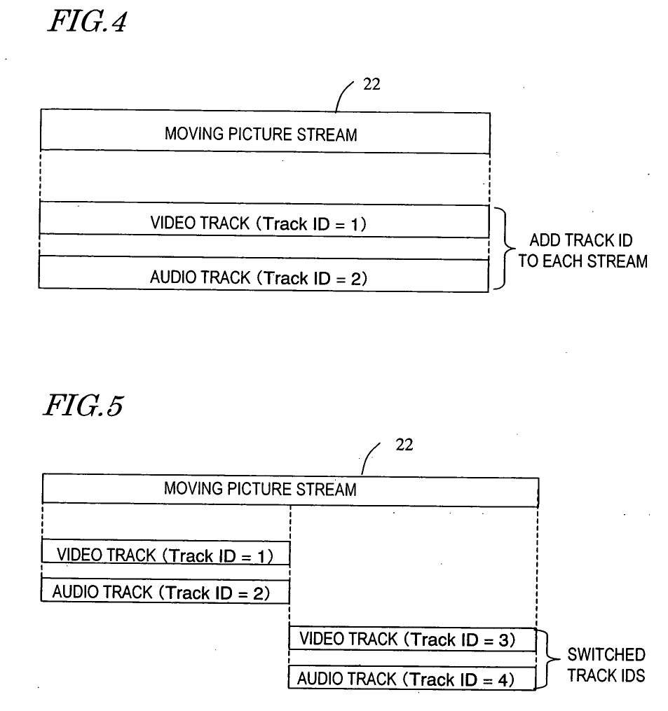

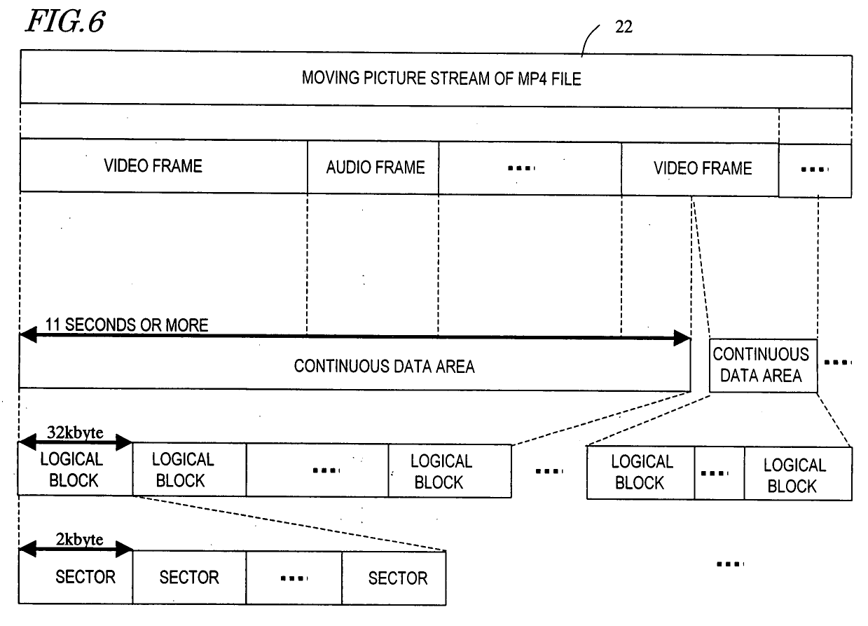

If the PC 10-3 has application software or hardware that can cope with the MP4 stream processing of the present invention, then the PC 10-3 can play back the MP4 streams just as defined by the MP4 file standard. On the other hand, if the PC 10-3 cannot cope with the MP4 stream processing of the present invention, then the PC 10-3 can play back the moving picture streams in accordance with the MPEG-2 system standard. It should be noted that the PC 10-3 can also perform editing processing such as partial deletion on the MP4 streams. As used herein, the term “playback” includes such editing processing. In the following description, the portable videocorder 10-1, movie recorder 10-2 and PC 10-3 shown in FIG. 1 will be collectively referred to as a “data processor”.

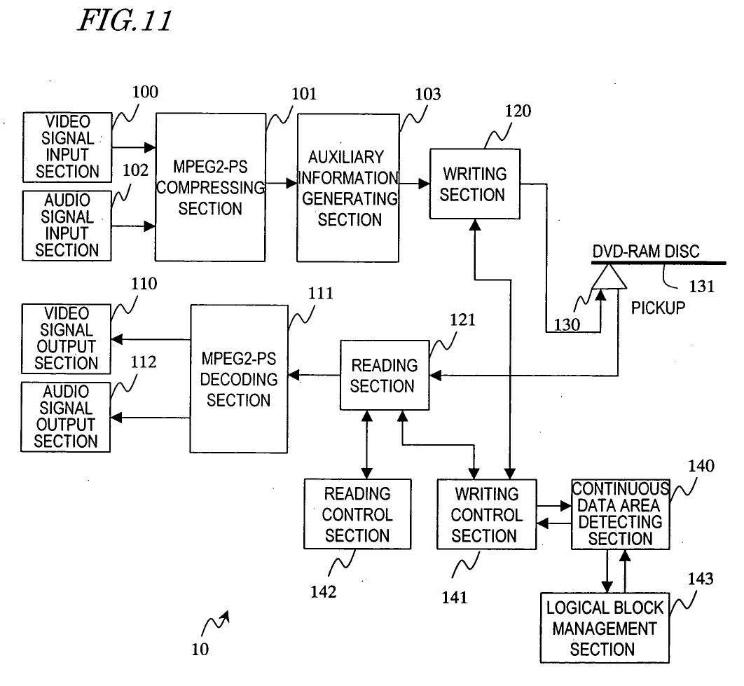

FIG. 11 shows an arrangement of functional blocks in a data processor 10. In the following description, the data processor 10 is supposed to have the capabilities of both reading and writing an MP4 stream. More specifically, the data processor 10 can not only generate an MP4 stream and write it on a storage medium 131 but also read an MP4 stream that is stored on the storage medium 131. The storage medium 131 may be a DVD-RAM disc, for example, and will be referred to herein as a “DVD-RAM disc 131”.

First, the MP4 stream writing function of the data processor 10 will be described. The data processor 10 includes a video signal input section 100, an MPEG2-PS compressing section 101, an audio signal input section 102, an auxiliary information generating section 103, a writing section 120, an optical pickup 130 and a writing control section 141 as respective components regarding this function.

The video signal input section 100 is implemented as a video signal input terminal and receives a video signal representing video data. The audio signal input section 102 is implemented as an audio signal input terminal and receives an audio signal representing audio data. For example, the video signal input section 100 and audio signal input section 102 of the portable videocorder 10-1 (see FIG. 10) may be connected to the video output section and audio output section of a tuner section (not shown) to receive a video signal and an audio signal, respectively. Also, the video signal input section 100 and audio signal input section 102 of the movie recorder 10-2 (see FIG. 10) may respectively receive a video signal and an audio signal from the CCD output (not shown) and microphone output of a camera.

The MPEG2-PS compressing section (which will be simply referred to herein as a “compressing section”) 101 receives the video and audio signals, thereby generating an MPEG-2 program stream (which will be referred to herein as an “MPEG2-PS”) compliant with the MPEG-2 system standard. The MPEG2-PS generated may be decoded by itself in accordance with the MPEG-2 system standard. The MPEG2-PS will be described in further detail later.

The auxiliary information generating section 103 generates auxiliary information for the MP4 stream. The auxiliary information includes reference information and attribute information. The reference information is used to identify the MPEG2-PS that has been generated by the compressing section 101 and may include the file name of the MPEG2-PS being written and its storage location on the DVD-RAM disc 131. On the other hand, the attribute information describes the attributes of a sample unit of the MPEG2-PS. As used herein, the “sample” refers to the minimum management unit in a sample description atom (to be described later) as in the auxiliary information defined by the MP4 file standard. The attribute information includes data size, playback time and so on for each sample. One sample may be a data unit that can be accessed at random, for example. In other words, the attribute information is needed to read the sample. Among other things, the sample description atom (to be described later) is sometimes called “access information”.

Specific examples of the attribute information include the address of the data storage location, a time stamp representing playback timing, an encoding bit rate, and information about codec. The attribute information is provided for each of the video data and the audio data in every sample. Except for the field description to be mentioned explicitly soon, the attribute information complies with the contents of auxiliary information for a conventional MP4 stream 20.

As will be described later, one sample according to the present invention is a single video object unit (VOBU) in the MPEG2-PS. It should be noted that “VOBU” refers to the video object unit as defined by the DVD Video recording standard. The auxiliary information will be described in further detail later.

In accordance with the instruction given by the writing control section 141, the writing section 120 controls the pickup 130, thereby writing data at a particular location (i.e., address) on the DVD-RAM disc 131. More specifically, the writing section 120 writes the MPEG2-PS, generated by the compressing section 101, and the auxiliary information, generated by the auxiliary information generating section 103, on the DVD-RAM disc 131 as respectively different files.

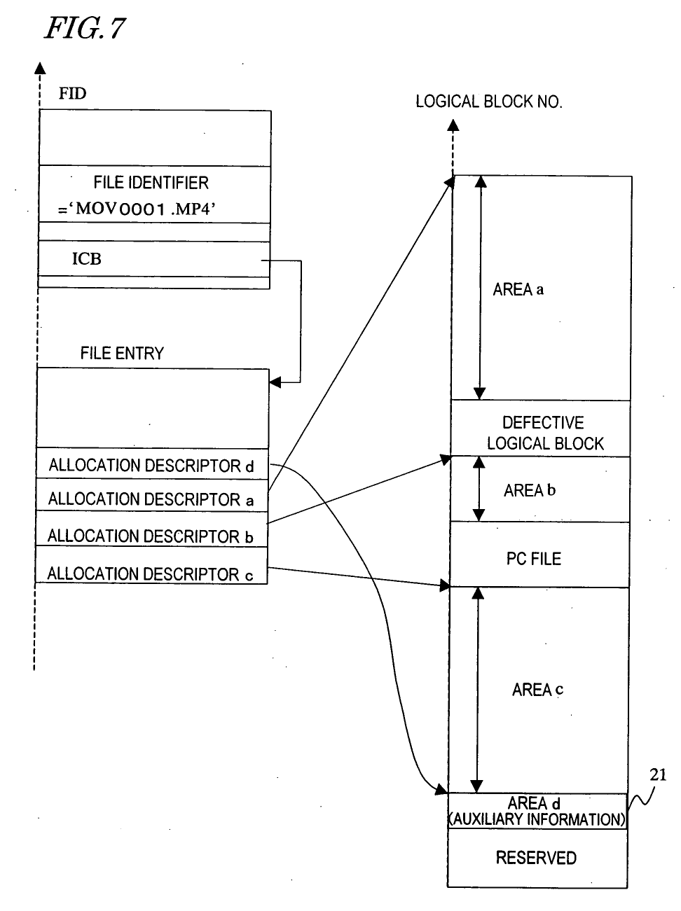

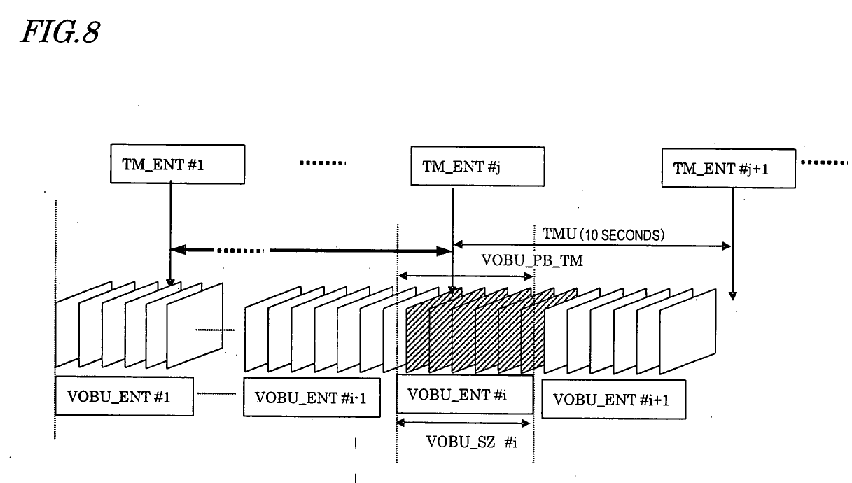

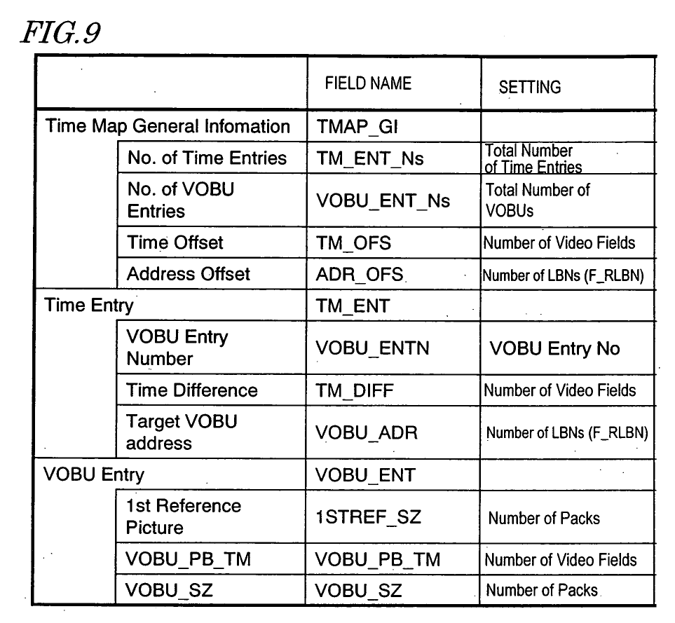

The data processor 10 further includes a continuous data area detecting section (which will be simply referred to herein as a “detecting section”) 140 and a logical block management section (which will be simply referred to herein as a “management section”) 143 that operate during the data write operation. In accordance with the instruction given by the writing control section 141, the continuous data area detecting section 140 checks the availability of sectors, which are managed by the logical block management section 143, thereby detecting a physically continuous unused area available. The writing control section 141 instructs the writing section 120 to write the data on that unused area. A specific data writing method may be similar to that already described with reference to FIG. 7, there is no particularly important difference, and the detailed description thereof will be omitted herein. It should be noted that the MPEG2-PS and the auxiliary information are written as separate files. Thus, their respective file names are written on the file identifiers shown in FIG. 7.

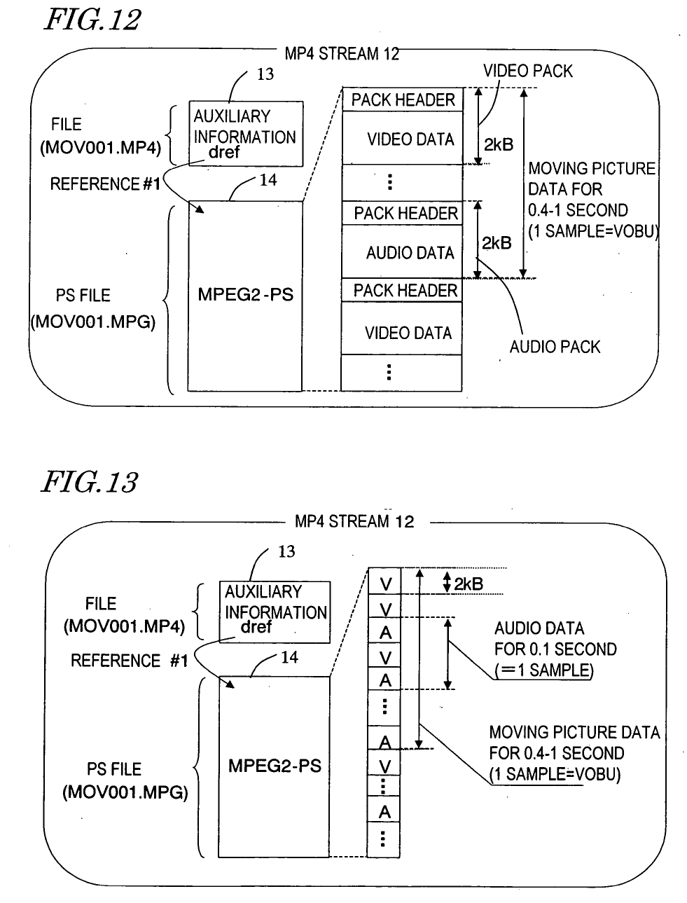

Hereinafter, the data structure of the MP4 stream will be described with reference to FIG. 12. FIG. 12 shows the data structure of an MP4 stream according to the present invention. The MP4 stream 12 includes an auxiliary information file (MOV001.MP4) including the auxiliary information 13 and a data file (MOV001.MPG) of the MPEG2-PS 14 (which will be referred to herein as a “PS file”). A single MP4 stream is made up of the data stored in these two files. In this description, the same name “MOV001” is given to the auxiliary information file and PS file to clearly indicate that these two files belong to the same MP4 stream but different extensions are given to them. More specifically, the same extension “MP4” as that of a conventional MP4 file is adopted as the extension of the auxiliary information file, while an extension “MPG” normally used in a conventional program stream is adopted as the extension of the PS file.

The auxiliary information 13 includes reference information dref to make reference to the MPEG2-PS 14 and further includes attribute information that describes the attributes of each video object unit (VOBU) of the MPEG2-PS 14. Since the attribute information describes the attributes of each VOBU, the data processor 10 can find a VOBU at any arbitrary location in the MPEG2-PS 14 on a VOBU basis and can perform playback and editing processing thereon.

The MPEG2-PS 14 is a moving picture stream, which is compliant with the MPEG-2 system standard and which is made up of video and audio packs that are interleaved together. Each video pack includes a pack header and encoded video data, while each audio pack includes a pack header and encoded audio data. In the MPEG2-PS 14, the data is managed on a video object unit (VOBU) basis, where a VOB includes moving picture data, each unit of which has a length corresponding to a video playback duration of 0.4 to 1 second. The moving picture data includes a plurality of video packs and a plurality of audio packs. By reference to the information described in the auxiliary information 13, the data processor 10 can locate and read any arbitrary VOBU. It should be noted that each VOBU includes at least one GOP.

The MP4 stream 12 of the present invention is partly characterized in that the MPEG2-PS 14 can be decoded not only by reference to the attribute information 13, which complies with the data structure of an MP4 stream as defined by the MPEG-4 system standard, but also in accordance with the MPEG-2 system standard. The auxiliary information file and the PS file are stored separately, and therefore, the data processor 10 can analyze and process them independently of each other. For example, an MP4 stream player, which can carry out the data processing of the present invention, can adjust the playback duration of the MP4 stream 12 according to the attribute information 13, sense the encoding method of the MPEG2-PS 14 and decode it by its associated decoding method. On the other hand, a conventional apparatus that can decode an MPEG2-PS may decode it in accordance with the MPEG-2 system standard. Thus, even any currently popular version of software or hardware, which is compliant with only the MPEG-2 system standard, can also play back a moving picture stream included in the MP4 stream.

Optionally, not only the sample description atom on the VOBU basis but also another sample description atom, which uses a number of frames of the audio data of the MPEG2-PS 14, corresponding to a predetermined amount of time, as a management unit, may be provided as shown in FIG. 13. The predetermined amount of time may be 0.1 second, for example. In FIG. 13, “V” denotes the video pack shown in FIG. 12 and “A” denotes the audio pack. An audio frame corresponding to 0.1 second is made up of at least one pack. As for AC-3, for example, one audio frame includes audio data corresponding to 1,536 samples supposing the sampling frequency is 48 kHz. In this case, the sample description atom may be provided either within a user data atom in a track atom or on an independent track. In another example, the auxiliary information 13 may use an audio frame, synchronized with a VOBU and corresponding to a duration of 0.4 second to 1 second, as a unit and may store various attributes such as the overall data size of the units, the data address of the top pack and a time stamp representing the output timing.

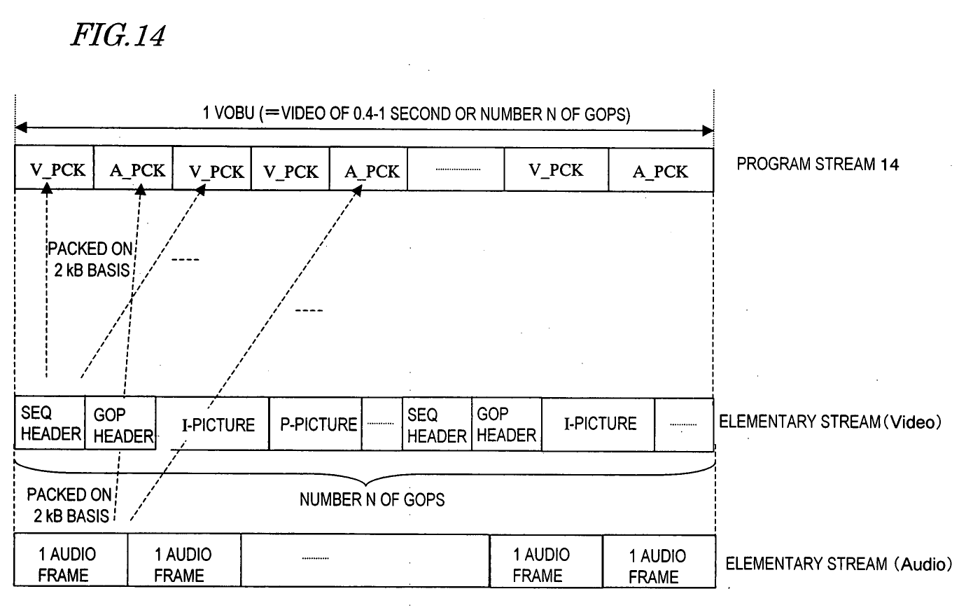

Next, the data structure of each video object unit (VOBU) of the MPEG2-PS 14 will be described. FIG. 14 shows a correlation between a program stream and elementary streams. In the MPEG2-PS 14, a single VOBU includes a plurality of video packs V_PCK and a plurality of audio packs A_PCK. More exactly, a VOBU runs from a sequence header (i.e., SEQ header shown in FIG. 14) to a pack just before the next sequence header. That is to say, a sequence header is put at the top of each VOBU. On the other hand, the elementary stream (Video) includes a number N of GOPs, which include various types of headers (such as the sequence (SEQ) header and GOP header) and video data (including I-, P- and B-pictures). The elementary stream (Audio) includes a plurality of audio frames.

Each of the video and audio packs included in the VOBU of the MPEG2-PS 14 is composed of the data included in its associated elementary stream (Video) or (Audio) so as to have a data size of 2 kilobytes. As described above, each pack is provided with a pack header.

It should be noted that if another elementary stream (not shown) is provided for auxiliary video data such as subtitle data, then each VOBU of the MPEG2-PS 14 further includes packs of that auxiliary video data.

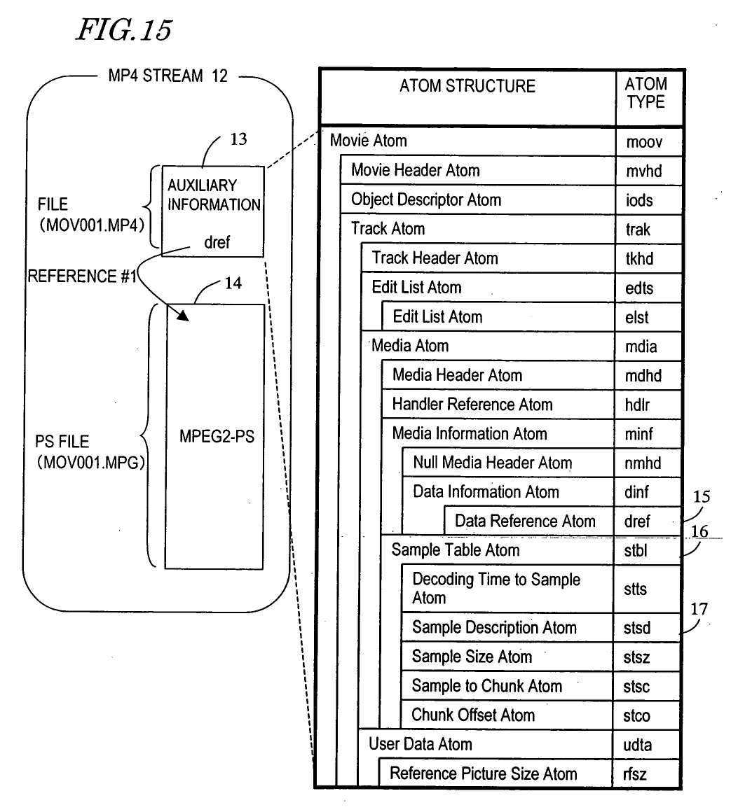

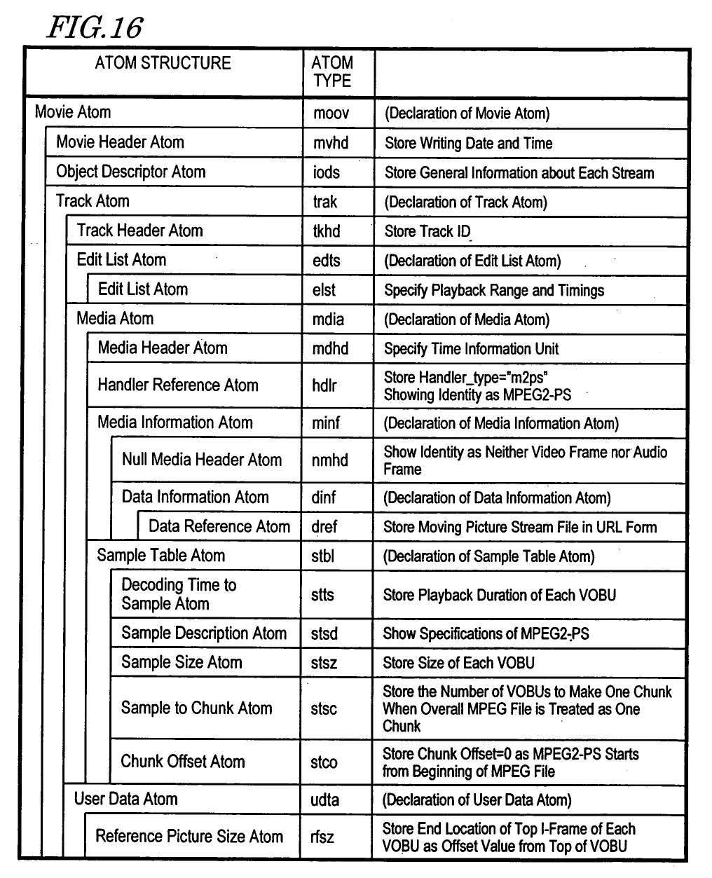

Next, the data structure of the auxiliary information 13 in the MP4 stream 12 will be described with reference to FIGS. 15 and 16. FIG. 15 shows the data structure of the auxiliary information 13. This data structure is called an “atom structure” and has a layered architecture. For example, “Movie Atom” includes “Movie Header Atom”, “Object Descriptor Atom” and “Track Atom”, which is further subdivided into “Track Header Atom”, “Edit List Atom”, “Media Atom” and “User Data Atom”. A similar statement applies to the other Atoms shown in FIG. 15.

According to the present invention, the attributes of a sample unit are described by using “Data Reference Atom (drf)” 15 and “Sample Table Atom (stbl)” 16, in particular. As described above, one sample corresponds to one video object unit (VOBU) of the MPEG2-PS. “Sample Table Atom” 16 includes the six low-order atoms shown in FIG. 15.

FIG. 16 shows the contents of respective atoms that make up the atom structure. “Data Reference Atom” stores the information identifying the file of a moving picture stream (i.e., the MPEG2-PS) 14 in the form of a URL. On the other hand, “Sample Table Atom” describes the attributes of respective VOBUs with its low-order atoms. For example, “Decoding Time to Sample Atom” stores the playback durations of the respective VOBUs. “Sample Size Atom” stores the data sizes of the respective-VOBUs. Also, “Sample Description Atom” shows that the PS file data making up the MP4 stream 12 is the MPEG2-PS 14 and also provides detailed specifications of the MPEG2-PS 14. In the following description, the information described by “Data Reference Atom” will be referred to herein as “reference information” and the information described by “Sample Table Atom” will be referred to herein as “attribute information”.

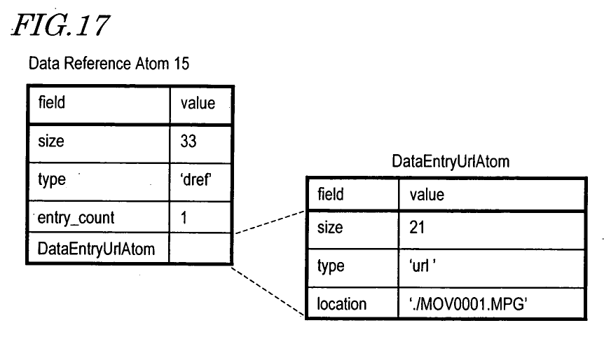

FIG. 17 shows a specific exemplary description format for “Data Reference Atom” 15. The information identifying the file is described in a portion (“DataEntryUrlAtom” in this example) of the field describing “Data Reference Atom” 15. In this case, the file name and file storage location of the MPEG2-PS 14 are described as a URL. By reference to “Data Reference Atom” 15, the MPEG2-PS 14, which makes up the MP4 stream 12 along with its auxiliary information 13, can be identified. It should be noted that even before the MPEG2-PS 14 is written on the DVD-RAM disc 131, the auxiliary information generating section 103 shown in FIG. 11 can also detect the file name and file storage location of the MPEG2-PS 14. This is because the file name can be determined in advance and because the file storage location can be logically identified by the notation of the layered structure of the file system.

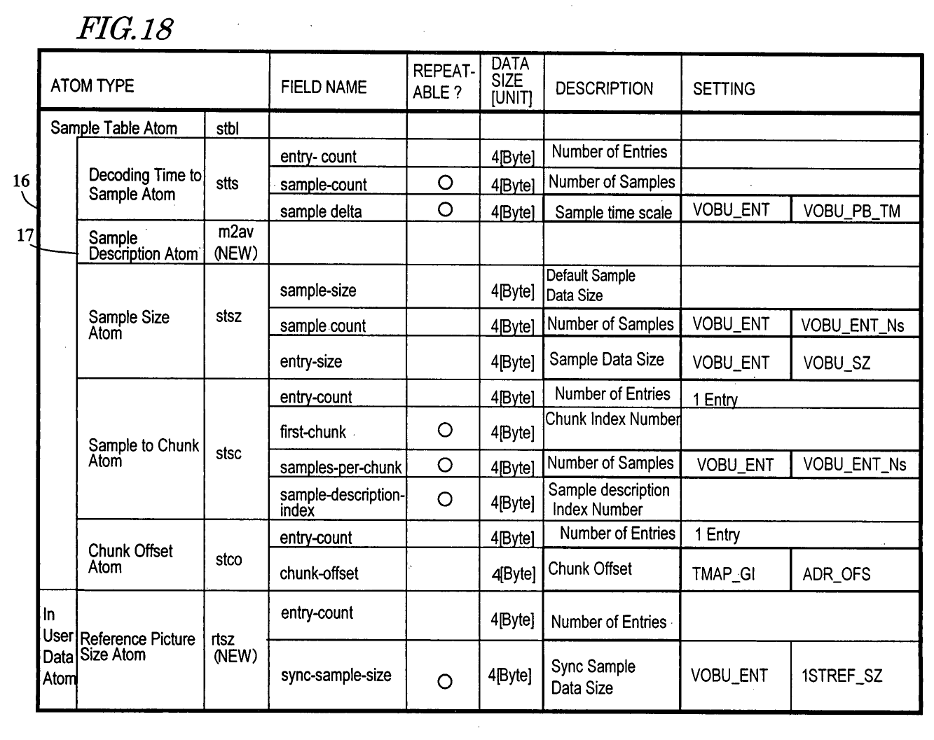

FIG. 18 shows specific exemplary descriptions of respective atoms included in “Sample Table Atom” 16. Each atom defines the field name, repeatability and data size. For example, “Sample Size atom” includes three fields “sample-size”, “sample count” and “entry-size”. Among these fields, the default data size of the VOBU is stored in the “sample-size” field, and an individual data size, which is different from the default value of the VOBU, is stored in the “entry-size” field. In the “setting” shown in FIG. 18, each parameter (such as “VOBU_ENT”) may have the same value as the access data of the same name according to the DVD Video standard.

In “Sample Description Atom” 17 shown in FIG. 18, the attribute information of the sample unit is described. Hereinafter, the contents of the information described in “Sample Description Atom” 17 will be described.

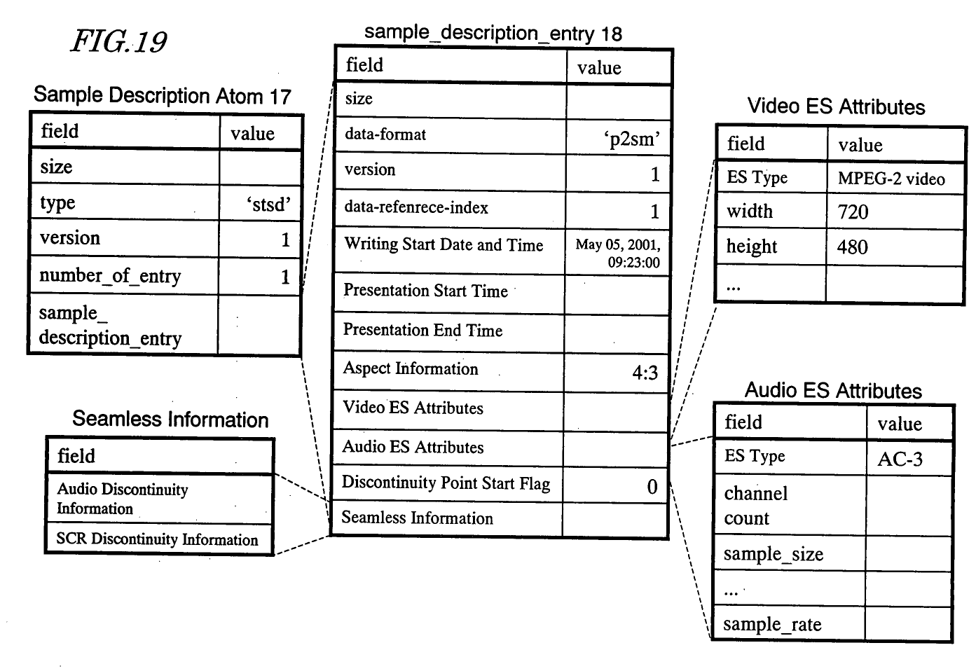

FIG. 19 shows a specific exemplary description format for “Sample Description Atom” 17. “Sample Description Atom” 17 describes its data size and the attribute information of a sample unit when each VOBU is a single sample. The attribute information is described in “sample_description_entry” 18 of “Sample Description Atom” 17.

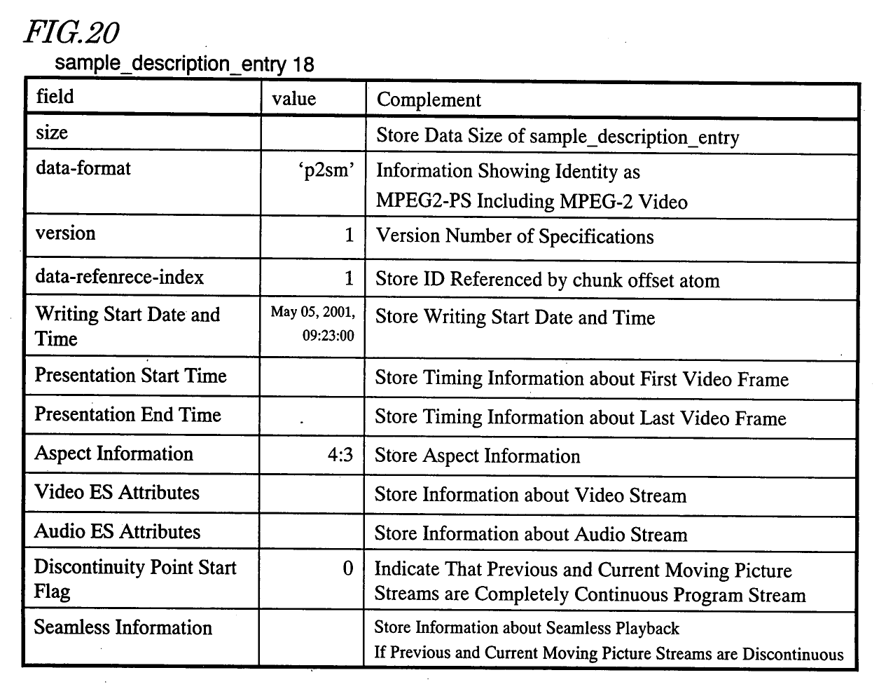

FIG. 20 shows the contents of respective fields of “sample_description_entry” 18. The entry 18 includes “data format” specifying the encoding method of its associated MPEG2-PS 14. In FIG. 20, “p2sm” shows that the MPEG2-PS 14 is an MPEG-2 program stream including MPEG-2 Video.

The entry 18 includes that sample's “Presentation Start Time” and “Presentation End Time”, which store the timing information of the first video frame and the timing information of the last video frame, respectively. The entry 18 further includes the attribute information (“Video ES Attribute”) of the video stream within the sample and the attribute information (“Audio ES Attribute”) of the audio stream within the same sample. As shown in FIG. 19, the video data attribute information may define the CODEC type of the video (e.g., MPEG-2 Video) and the width and height (“width” and “height”) of the video data, for example. In the same way, the audio data attribute information may define the CODEC type of the audio (e.g., AC-3), the number of channels of the audio data (“channel count”), the size of the audio sample (“samplesize”) and the sampling rate thereof (“samplerate”).

The entry 18 further includes a discontinuity point start flag and seamless information. These pieces of information are described if there are a number of PS streams in a single MP4 stream 12 as will be described later. For example, a discontinuity point start flag of “0” indicates that the previous moving picture stream and the current moving picture stream are a completely continuous program stream. On the other hand, a discontinuity point start flag of “1” shows that those moving picture streams are discontinuous program streams. If those streams are discontinuous, the seamless information may be described in order to play back a moving picture or audio without a break even at a discontinuity point of the moving picture or audio. The seamless information includes audio discontinuity information and SCR discontinuity information during the playback. The audio discontinuity information includes the presence or absence of a mute interval (i.e., the audio gap shown in FIG. 31), the start timing and the time length thereof. The SCR discontinuity information includes the SCR values of the two packs that are just before, and just after, the discontinuity point.

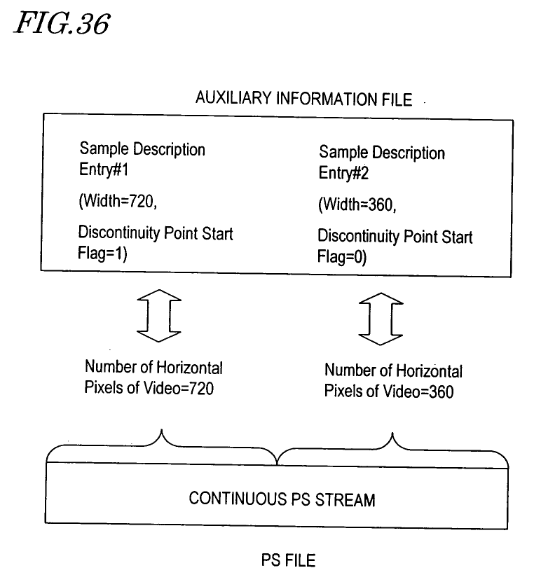

By providing the discontinuity point start flag, the switching point of Sample Description Entries and the continuity switching point of moving picture streams can be defined independently of each other. As shown in FIG. 36, if the number of recording pixels changes on the way, then Sample Descriptions are changed. In this case, however, if the moving picture streams themselves are continuous, then the discontinuity point start, flag may set to zero. If the discontinuity point start flag is zero, a PC, which is directly editing an information stream, can understand that seamless playback is realized even without resetting a connection point between two moving picture streams. FIG. 36 shows a situation where the number of horizontal pixels has changed. However, the same technique is also applicable to a situation where any other type of attribute information has changed. For example, a situation where a 4:3 aspect ratio has changed into 16:9 as to the aspect information or a situation where the audio bit rate has changed may also be coped with.

The data structures of the auxiliary information 13 and MPEG2-PS 14 of the MP4 stream 12 shown in FIG. 12 have been described. According to the data structure described above, any portion of the MPEG2-PS 14 may be deleted just by changing the attribute information (e.g., the time stamp) in the auxiliary information 13, and there is no need to change the time stamp provided for the MPEG2-PS 14. Thus, the editing can be done by taking advantage of a conventional MP4 stream. In addition, according to the data structure described above, if a moving picture is being edited on a PC with application or hardware compatible with a stream compliant with the MPEG-2 system standard, just a PS file may be imported into the PC. This is because the MPEG2-PS 14 of the PS file is a moving picture stream compliant with the MPEG-2 system standard. Such application or hardware has circulated widely, and therefore, any piece of existent software or hardware can be used effectively. In addition, the auxiliary information can be stored in a data structure compliant with the ISO standard.

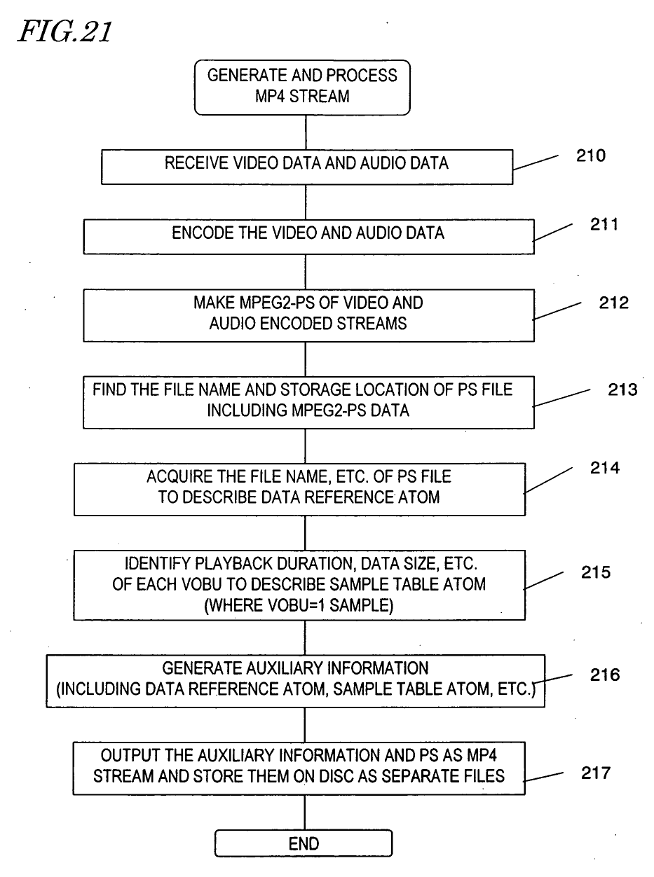

Hereinafter, it will be described with reference to FIGS. 11 and 21 how the data processor 10 generates an MP4 stream and writes it on a DVD-RAM disc 131. FIG. 21 is a flowchart showing a procedure to generate the MP4 stream. First, in Step 210, the data processor 10 receives video data through the video signal input section 100 and audio data through the audio signal input section 102, respectively. Next, in Step 211, the compressing section 101 encodes the received video and audio data in accordance with the MPEG-2 system standard. Subsequently, in Step 212, the compressing section 101 makes up an MPEG2-PS of the video and audio encoded streams (see FIG. 14).

Then, in Step 213, the writing section 120 determines the file name and storage location of the MPEG2-PS to be written on the DVD-RAM disc 131. Next, in Step 214, the auxiliary information generating section 103 acquires the file name and storage location of the PS file and specifies the contents to be described as the reference information (i.e., Data Reference Atom shown in FIG. 17). As shown in FIG. 17, a description method that makes it possible to specify the file name and the storage location at the same time is adopted herein.

Subsequently, in Step 215, the auxiliary information generating section 103 acquires data representing the playback duration, data size and so on for each of the VOBUs defined in the MPEG2-PS 14 and specifies the contents to be described as the attribute information (i.e., Sample Table Atom shown in FIGS. 18 through 20). By providing the attribute information for each VOBU, any arbitrary VOBU can be read and decoded. This means that one VOBU is handled as one sample.

Thereafter, in Step 216, the auxiliary information generating section 103 generates the auxiliary information based on the reference information (i.e., Data Reference Atom) and the attribute information (i.e., Sample Table Atom).

Next, in Step 217, the writing section 120 outputs the auxiliary information 13 and MPEG2-PS 14 as the MP4 stream 12 and writes them on the DVD-RAM disc 131 as an auxiliary information file and a PS file, respectively. By performing this procedure, the MP4 stream is generated and written on the DVD-RAM disc 131.

Hereinafter, the MP4 stream reading function of the data processor 10 will be described with reference to FIGS. 11 and 12. On the DVD-RAM disc 131, the MP4 stream 12, including the auxiliary information 13 and MPEG2-PS 14 having the data structures described above, is supposed to be stored. Upon a user's request, the data processor 10 reads and decodes the MPEG2-PS 14 that is stored on the DVD-RAM disc 131. The data processor 10 includes a video signal output section 110, an MPEG2-PS decoding section 111, an audio signal output section 112, a reading section 121, the pickup 130 and a reading control section 142 as respective components realizing the reading function.

First, in accordance with an instruction given by the reading control section 142, the reading section 121 controls the pickup 130 so as to read the MP4 file from the DVD-RAM disc 131 and acquire the auxiliary information 13. The reading section 121 outputs the acquired auxiliary information 13 to the reading control section 142. Also, in response to a control signal supplied from the reading control section 142 to be described later, the reading section 121 reads the PS file from the DVD-RAM disc 131. The control signal is a signal designating the PS file to read (“MOV001.MPG”).

The reading control section 142 receives the auxiliary information 13 from the reading section 121 and analyzes its data structure, thereby acquiring the reference information 15 (see FIG. 17) contained in the auxiliary information 13. Then, the reading control section 142 outputs a control signal instructing that the PS file (“MOV001.MPG”) designated by the reference information 15 be read from the specified location (i.e., “./” or root directory).

The MPEG2-PS decoding section 111 receives the MPEG2-PS 14 and the auxiliary information 13 and decodes the MPEG2-PS 14 into video data and audio data in accordance with the attribute information contained in the auxiliary information 13. More specifically, the MPEG2-PS decoding section 111 reads the data format (“data_format”), the video stream attribute information (“video ES attribute”) and the audio stream attribute information (“audio ES attribute”) of Sample Description Atom 17 (see FIG. 19), and decodes the video and audio data in accordance with the encoding method, the presentation size of the video data and the sampling frequency as defined by those pieces of information.

The video signal output section 110 is implemented as a video signal output terminal to output the decoded video data as a video signal, while the audio signal output section 112 is implemented as an audio signal output terminal to output the decoded audio data as an audio signal.

The MP4 stream reading process by the data processor 10 begins by reading a file with an extension “MP4” (i.e., “MOV001.MP4”) as in the conventional process of reading an MP4 stream file. More specifically, this process may be carried out in the following manner. First, the reading section 121 reads the auxiliary information file (“MOV001.MP4”). Next, the reading control section 142 analyzes the auxiliary information 13, thereby extracting the reference information (i.e., Data Reference Atom). Then, in accordance with the reference information extracted, the reading control section 142 outputs a control signal instructing that the PS file, making up the same MP4 stream, be read. In this preferred embodiment, the control signal output by the reading control section 142 instructs that the PS file (“MOV001.MPG”) be read.

Next, in response to the control signal, the reading section 121 reads the designated PS file. Thereafter, the MPEG2-PS decoding section 111 receives the MPEG2-PS 14 and auxiliary information 13 contained in the data file read and analyzes the auxiliary information 13, thereby extracting the attribute information. Then, by reference to Sample Description Atom 17 (see FIG. 19) included in the attribute information, the MPEG2-PS decoding section 111 identifies the data format of the MPEG2-PS 14 (“data_format”), the attribute information of the video stream included in the MPEG2-PS 14 (“video ES attribute”) and the attribute information of the audio stream (“audio ES attribute”), thereby decoding the video data and audio data. By performing these processing steps, the MPEG2-PS 14 is read in accordance with the auxiliary information 13.

It should be noted that any conventional player or playback software that can read a stream compliant with the MPEG-2 system standard can read the MPEG2-PS 14 just by reading the PS file. In that case, however, the player does not have to be able to read the MP4 stream 12. Since the MP4 stream 12 is made up of the auxiliary information 13 and MPEG2-PS 14 as two separate files, the PS file in which the MPEG2-PS 14 is stored can be easily identified by the extension, for example, and read.

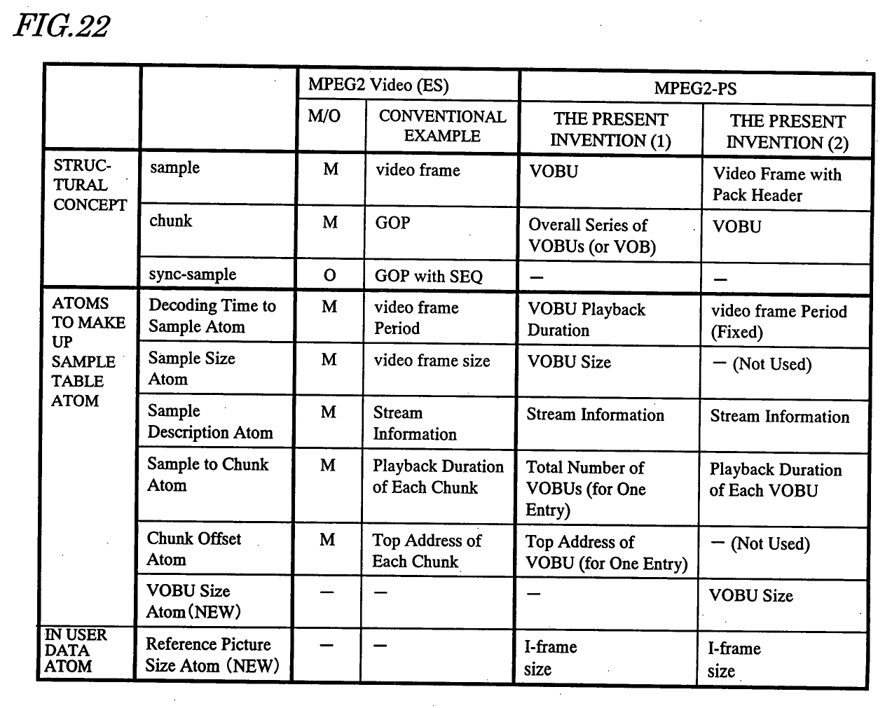

FIG. 22 is a table showing the differences between the MPEG2-PS generated by the processing of the present invention and a conventional MPEG-2 Video (elementary stream). In FIG. 22, the column “the present invention (1)” summarizes the above example in which one VOBU is handled as one sample. In the conventional example, one video frame is handled as one sample and attribute information (access information) such as Sample Table Atom is provided for each sample. In contrast, according to the present invention, a VOBU including a plurality of video frames is used as a sample unit and the access information is provided for each sample, thus cutting down the amount of attribute information significantly. That is why one VOBU is preferably treated as one sample as in the present invention.

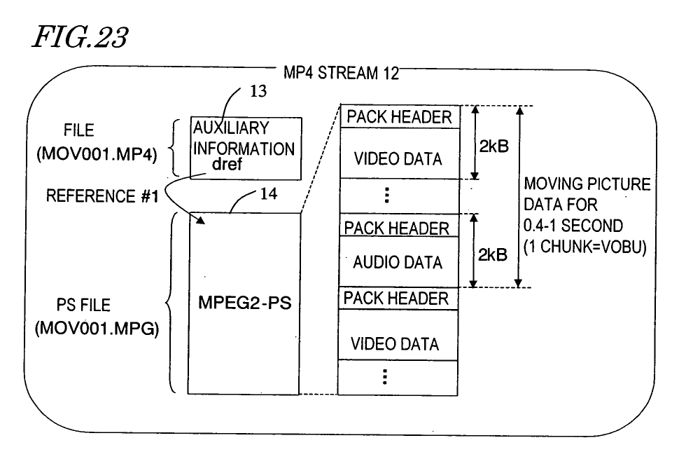

In FIG. 22, the column “the present invention (2)” shows a modified example of the data structure of “the present invention (1)”. The difference between “the present invention (2)” and “the present invention (1)” lies in that in this modified example (i.e., the present invention (2)), one VOBU corresponds to one chunk and that the access information is defined on a chunk-by-chunk basis. As used herein, one “chunk” is a unit consisting of a plurality of samples. In this example, a video frame including the pack header of the MPEG2-PS 14 corresponds to one sample. FIG. 23 shows the data structure of the MP4 stream 12 in a situation where one VOBU is handled as one chunk. The difference is that each sample shown in FIG. 12 is replaced by one chunk. In the conventional example, one video frame is handled as one sample and one GOP is treated as one chunk.

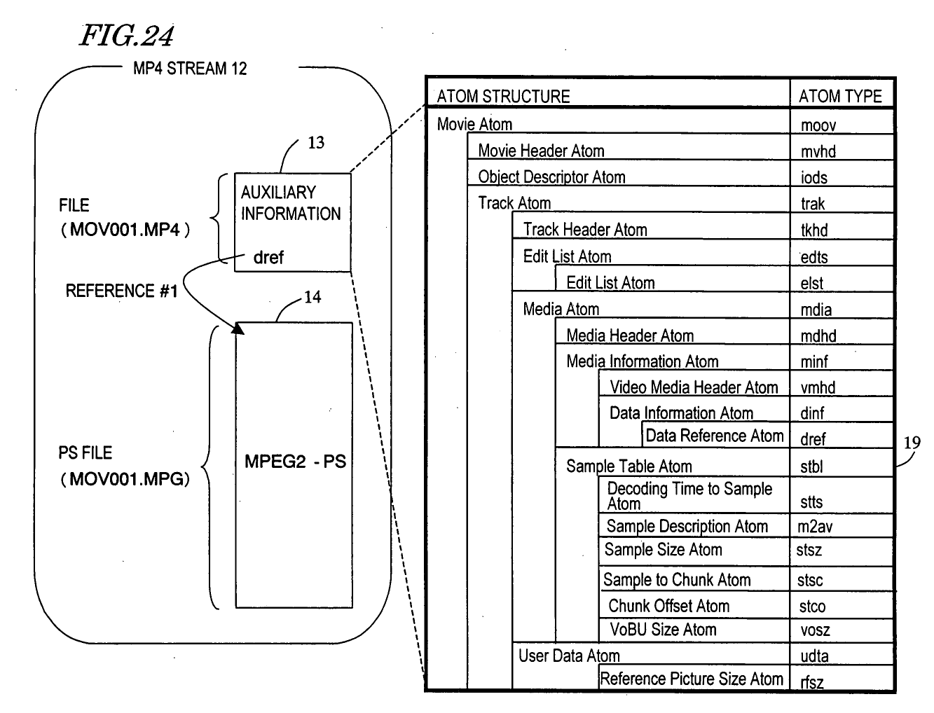

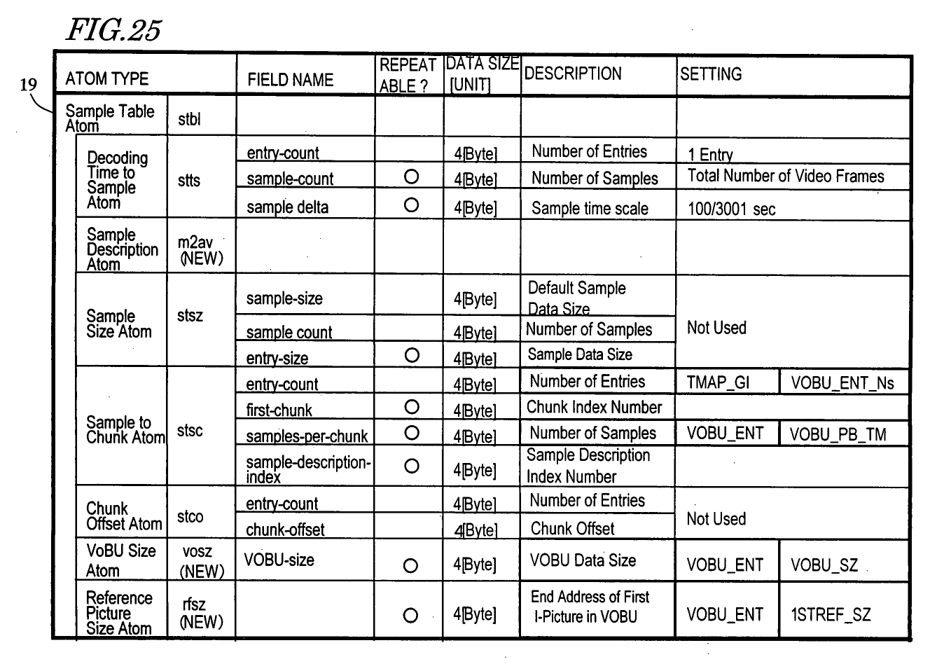

FIG. 24 shows the data structure in the situation where one VOBU is handled as one chunk. Comparing this data structure with that shown in FIG. 15 in which one VOBU is treated as one sample, it can be seen that the contents defined by Sample Table Atom 19 included in the attribute information of the auxiliary information 13 are different. FIG. 25 shows specific exemplary descriptions of respective atoms included in Sample Table Atom 19 in the situation where one VOBU is handled as one chunk.

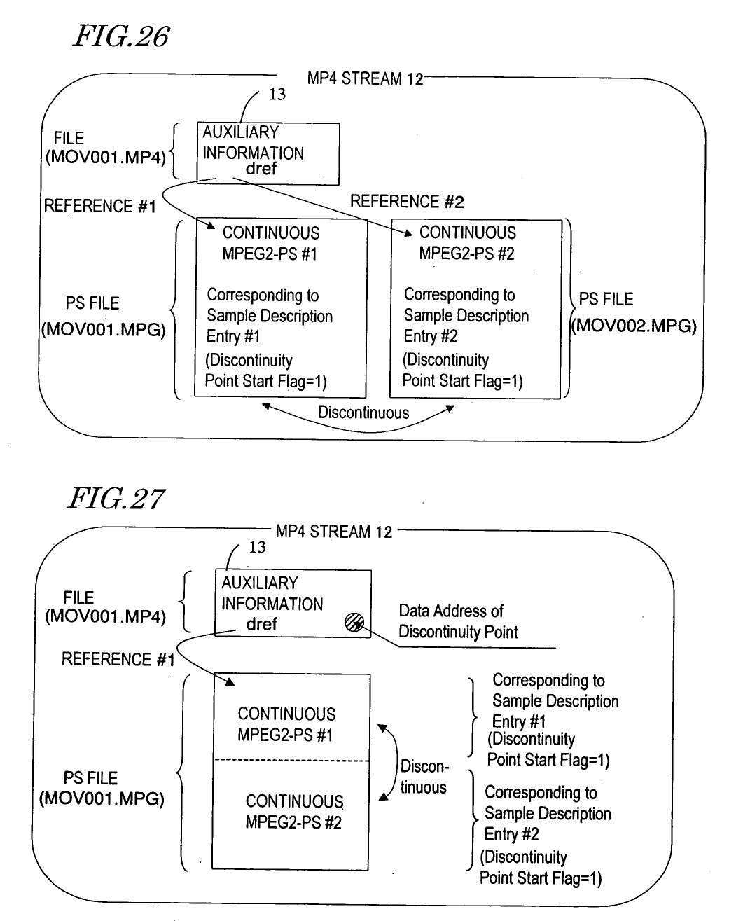

Hereinafter, a modified example of the PS file to make up the MP4 stream 12 will be described. FIG. 26 shows an exemplary MP4 stream 12 in which two PS files (“MOV001.MPG” and “MOV002.MPG”) are provided for a single auxiliary information file (“MOV001.MP4”). In these two PS files, the data of the MPEG2-PS 14, representing mutually different moving picture scenes, are stored separately. Within each PS file, the moving picture stream is continuous, and each of a system clock reference (SCR), a presentation time stamp (PTS) and a decoding time stamp (DTS), which are all compliant with the MPEG-2 system standard, is continuous, too. However, the SCR's, PTS's and DTS's are not continuous with each other between the two PS files (i.e., between the end of MPEG2-PS #1 included in one PS file and the beginning of MPEG2-PS #2 included in the other PS file). These two PS files are treated as separate tracks (diagrams).

In the auxiliary information file, reference information (dref, see FIG. 17) for identifying the file names and storage locations of the respective PS files is described. The reference information may be described in the order of items to be referred to, for example. In FIG. 26, the PS file “MOV001.MPG” identified by Reference #1 is read first, and then the PS file “MOV002.MPG” identified by Reference #2 is read. Even if there are a number of PS files in this manner, those PS files can be read substantially continuously by providing reference information for the respective PS files within the auxiliary information file.

FIG. 27 shows an example in which there are a number of discontinuous MPEG2-PS's within one PS file. In the PS file, MPEG2-PS's #1 and #2, representing different moving picture scenes, are arranged back to back. The “discontinuous MPEG2-PS's” mean that the SCR's, PTS's and DTS's are not continuous with each other between the two MPEG2-PS's (i.e., between the end of MPEG2-PS #1 and the beginning of MPEG2-PS #2). In other words, it means that the read timings are not continuous with each other. The discontinuity point is located in the boundary between the two MPEG2-PS's. It should be noted that within each MPEG2-PS, the moving picture stream is continuous and each of SCR, PTS and DTS, which are all compliant with the MPEG-2 system standard, is continuous, too.

In the auxiliary information file, reference information (dref, see FIG. 17) for identifying the file name and storage location of the PS file is described. A single piece of reference information designating the PS file is stored in the auxiliary information file. However, if that PS file were read sequentially, then the read operation would stop at the discontinuity point between MPEG2-PS #1 and MPEG2-PS #2 because the SCR's, PTS's and DTS's are discontinuous with each other there. Thus, information about this discontinuity point (e.g., location information (or address) of the discontinuity point) is described in the auxiliary information file. More specifically, the location information of the discontinuity point is stored as the “discontinuity point start flag” shown in FIG. 19. For example, during the read operation, the reading control section 142 detects the location information of the discontinuity point and reads the video data of MPEG2-PS #2, which is located after the discontinuity point, in advance, thereby controlling the read operation such that at least the video data can be played back without a break.

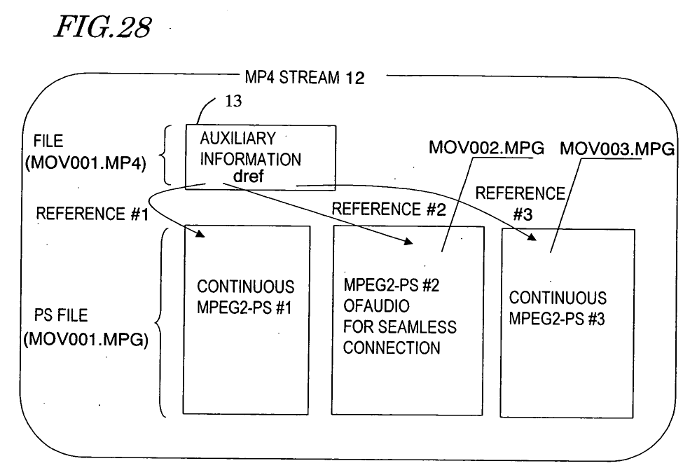

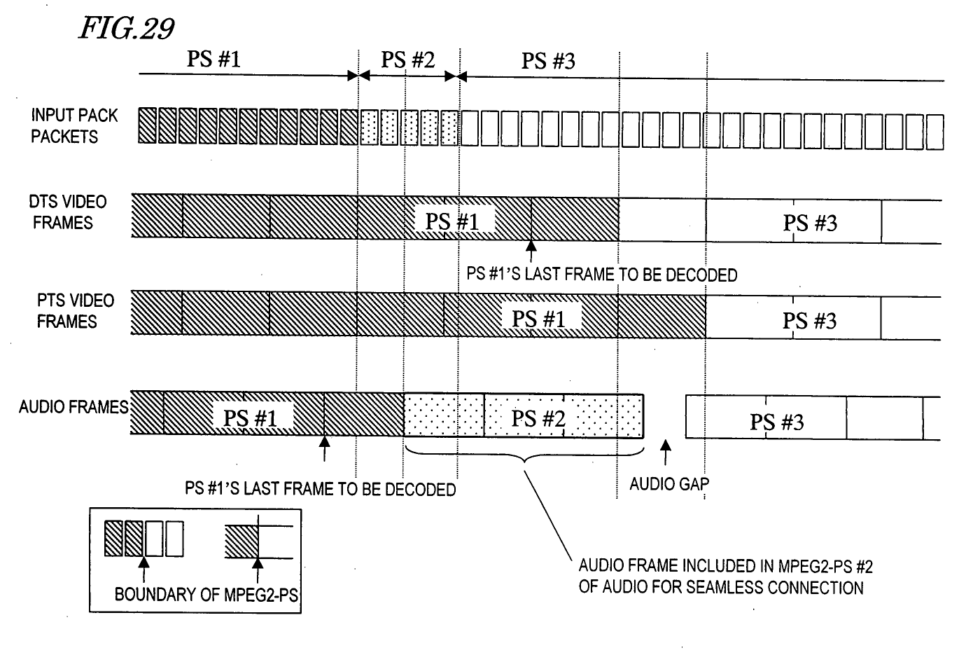

A procedure of reading two PS files, storing mutually discontinuous MPEG2-PS's, by providing two pieces of reference information for the files has been described with reference to FIG. 26. Optionally, as shown in FIG. 28, another PS file, storing an MPEG2-PS for the purpose of seamless connection, may be newly inserted between the two PS files such that the two original PS files can be read seamlessly. FIG. 28 shows an MP4 stream 12 in which a PS file (“MOV002.MPG”), storing an MPEG2-PS for the purpose of seamless connection, is provided. The PS file (“MOV002.MPG”) includes an audio frame that is absent from the discontinuity point between MPEG2-PS #1 and MPEG2-PS #3. This point will be described in further detail with reference to FIG. 29.

FIG. 29 shows the audio frame that is absent from the discontinuity point. In FIG. 29, the PS file storing MPEG2-PS #1 is identified by “PS #1” and the PS file storing MPEG2-PS #3 is identified by “PS #3”.

Suppose the data of PS #1 is processed first, and then that of PS #3 is processed. The DTS video frame on the second row and the PTS video frame on the third row represent time stamps of a video frame. As can be seen from these time stamps, PS files #1 and #3 can be played back without discontinuing the video. As to an audio frame, however, there is a mute interval, in which no data is present for a certain period of time, after PS #1 has been played and before PS #3 starts being played. With such an interval left, seamless playback could not be achieved.

Thus, PS #2 is newly provided and a PS file, including an audio frame for the purpose of seamless connection, is provided such that the auxiliary information file can make reference to that file. This audio frame includes audio data to fill the mute interval. For example, the audio data that was written synchronously with the end of the moving picture of PS #1 is copied. As can be seen from the audio frame row shown in FIG. 29, the audio frame for the purpose of seamless connection is inserted next to PS #1. The audio frame of PS #2 lasts until less than one frame before PS #3 begins. Accordingly, another piece of reference information (dref shown in FIG. 28) to make reference to this new PS #2 is provided for the auxiliary information 13 and is defined such that PS #2 is referred to after PS #1.

In FIG. 29, no data interval for less than one audio frame (i.e., a mute interval) is shown as “audio gap”. Alternatively, the mute interval may be eliminated by adding extra data for one more audio frame to PS #2. In that case, PS #2 and PS #3 will include a portion with the same audio data sample, i.e., a portion in which the audio frames overlap with each other. Even so, no serious problem should arise. This is because as to the overlapping portion, the same sound will be output no matter which data is read.

By performing these processing steps, even a number of discontinuous PS files can be read and decoded continuously with no time gap left.

In the example shown in FIG. 29, all PS files are supposed to be referred to by the reference information dref. However, just the PS #2 file may be referred to by any other atom (e.g., a uniquely defined dedicated atom) or the second PS track. In other words, only the PS files compliant with the DVD Video recording standard may be referred to by the dref atom. Alternatively, the audio frame in the PS #2 file may be stored as an independent file for the elementary stream, may be referred to by an independent audio track atom provided within the auxiliary information file, and may be described in the auxiliary information file so as to be played back in parallel with the end of PS #1. The timing of playing back PS #1 and the audio elementary stream simultaneously may be specified by Edit List Atom (see FIG. 15, for example) in the auxiliary information.

In the preferred embodiments described above, the moving picture stream is supposed to be an MPEG-2 program stream. Alternatively, the moving picture stream may also be an MPEG-2 transport stream (which will be referred to herein as an “MPEG2-TS”) as defined by the MPEG-2 system standard.

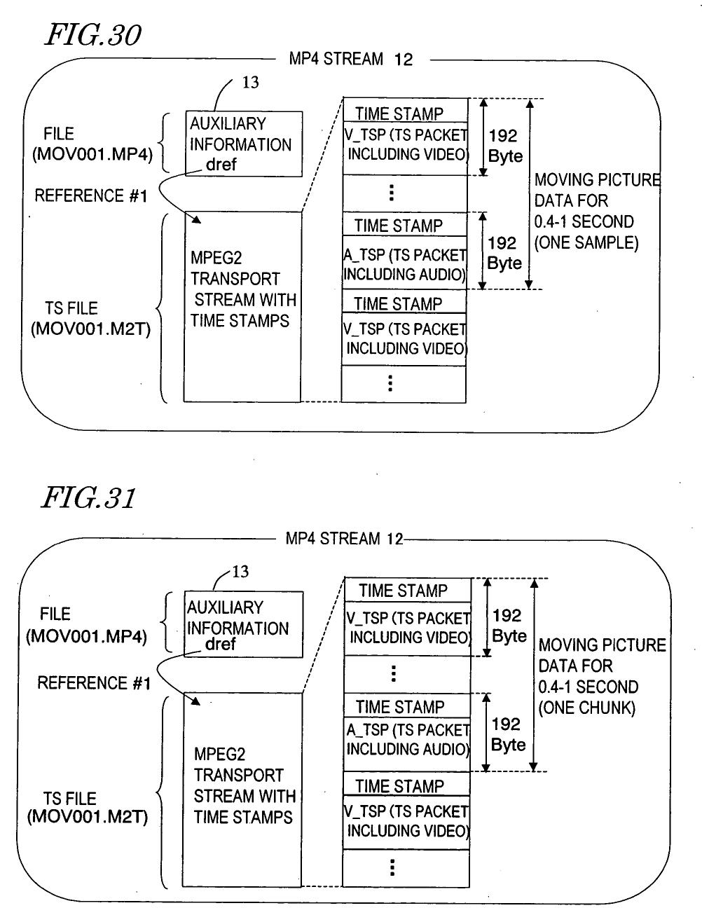

FIG. 30 shows the data structure of an MP4 stream 12 according to another example of the present invention. The MP4 stream 12 includes an auxiliary information file (“MOV001.MP4”), storing auxiliary information 13, and the data file (“MOV001.M2T”) of an MPEG2-TS 14 (which will be referred to herein as a “TS file”).

As in the MP4 stream 12 shown in FIG. 12, the TS file is also referred to by the reference information dref in the auxiliary information 13 in this MP4 stream 12.

A time stamp is added to the MPEG2-TS 14. More specifically, in this MPEG2-TS 14, a time stamp of 4 bytes to be referred to at the time of transmission is additionally provided before a transport packet (which will be referred to herein as a “TS packet”) of 188 bytes. Accordingly, a TS packet containing video (V_TSP) and a TS packet containing audio (A_TSP) are each made up of 192 bytes. It should be noted that the time stamp may be provided behind the TS packet.

In the MP4 stream 12 shown in FIG. 30, the attribute information may be described in the auxiliary information 13 with a TS packet, containing video data corresponding to a video playback duration of about 0.4 second to about 1 second, treated as one sample as in the VOBU shown in FIG. 12. In addition, as in FIG. 13, the data size, data address and playback timing of one frame of audio data may also be described in the auxiliary information.

Alternatively, one frame may be handled as one sample, and a plurality of frames may be treated as one chunk. FIG. 31 shows the data structure of an MP4 stream 12 according to still another example of the present invention. In this case, if a plurality of TS packets, each containing video data corresponding to a video playback duration of about 0.4 second to about 1 second, is handled as one chunk and if access information is defined on a chunk-by-chunk basis as in FIG. 23, then quite the same effects as those achieved by the MP4 stream 12 shown in FIG. 12 are also accomplished.

Even if the data structure shown in FIG. 30 or 31 is adopted, the arrangement of respective files and the processing to be carried out based on the data structure are similar to those already described with reference to FIGS. 12, 13 and 23. Thus, the description thereof will be omitted herein because it is easily understandable just by applying the statements about the video and audio packs shown in FIGS. 12, 13 and 23 to the video TS packet with the time stamp (V_TSP) and the audio TS packet with the time stamp (A_TSP) shown in FIG. 30.

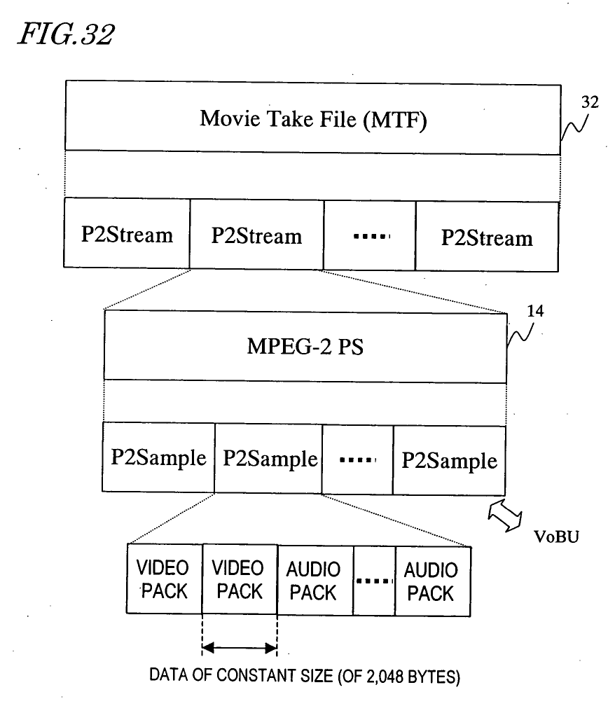

Next, the file structure of another data format, to which the data processing described above is also applicable, will be described with reference to FIG. 32. FIG. 32 shows the data structure of an MTF file 32. The MTF 32 is a file for storing a written or edited moving picture. The MTF file 32 includes a plurality of continuous MPEG2-PS's 14, while each MPEG2-PS 14 includes a plurality of samples (“P2Sample”). Every sample (“P2Sample”) is one continuous stream. For example, as already described with reference to FIG. 12, the attribute information may be defined on a sample basis. In the foregoing description, this sample (“P2 Sample”) corresponds to a VOBU. Every sample includes a plurality of video and audio packs, each of which contains a constant quantity of data of 2,048 bytes. Also, if two MTFs are combined together, then the resultant MTF will consist of at least two P2Stream's.

In the MTF 32, if two adjacent MPEG2-PS's 14 are one continuous program stream, then a single piece of reference information may be provided for the continuous range, thereby making up one MP4 stream. On the other hand, if two adjacent MPEG2-PS's 14 are a discontinuous program stream, then the data address of the discontinuity point may be included in the attribute information as shown in FIG. 27, thereby making up another MP4 stream 12. Thus, the data processing described above is applicable to the MTF 32, too.

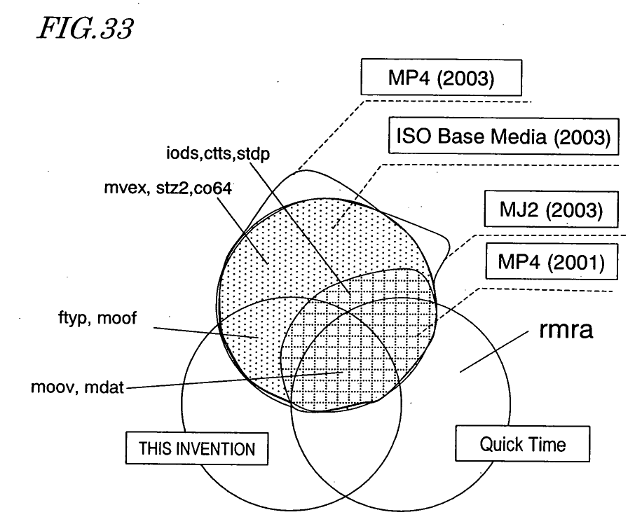

It has been described how to handle an MPEG-2 system stream by extending the MP4 file format that was standardized in 2001. Alternatively, according to the present invention, the MPEG-2 system stream may also be handled even by extending the QuickTime file format or the ISO Base Media file format, too. This is because most of the specifications of the MP4 file format and the ISO Base Media file format are defined based on, and have the same contents as, the QuickTime file format. FIG. 33 shows a correlation among various types of file format standards. For a type of atom (moov, mdat) in which “the present invention”, “MP4 (2001)” and “QuickTime” overlap with each other, the data structure of the present invention described above can be adopted. As already described, the atom type “moov” is shown in FIG. 15 and other drawings as “Movie Atom” of the highest-order layer of the auxiliary information.

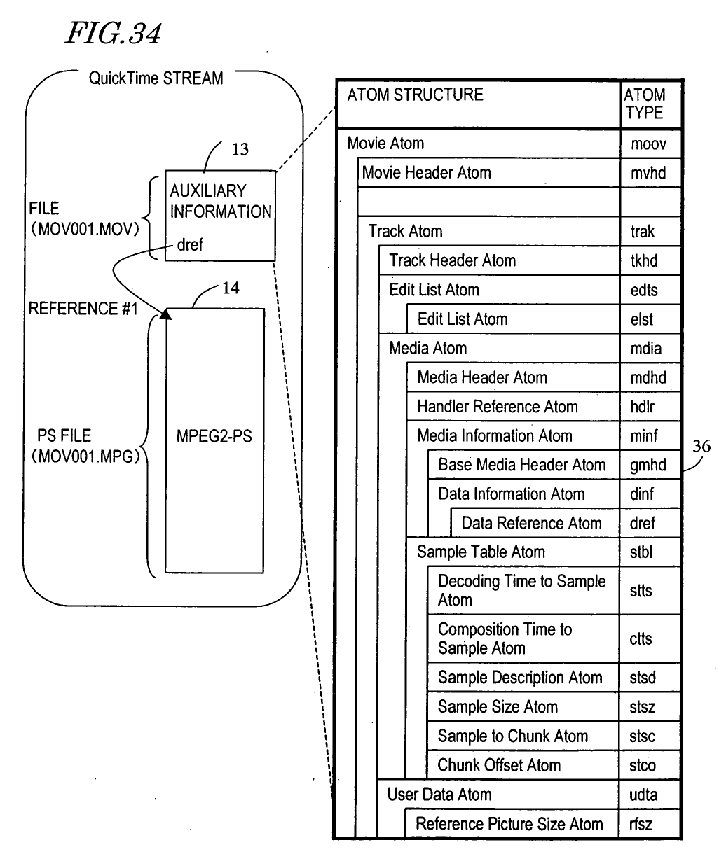

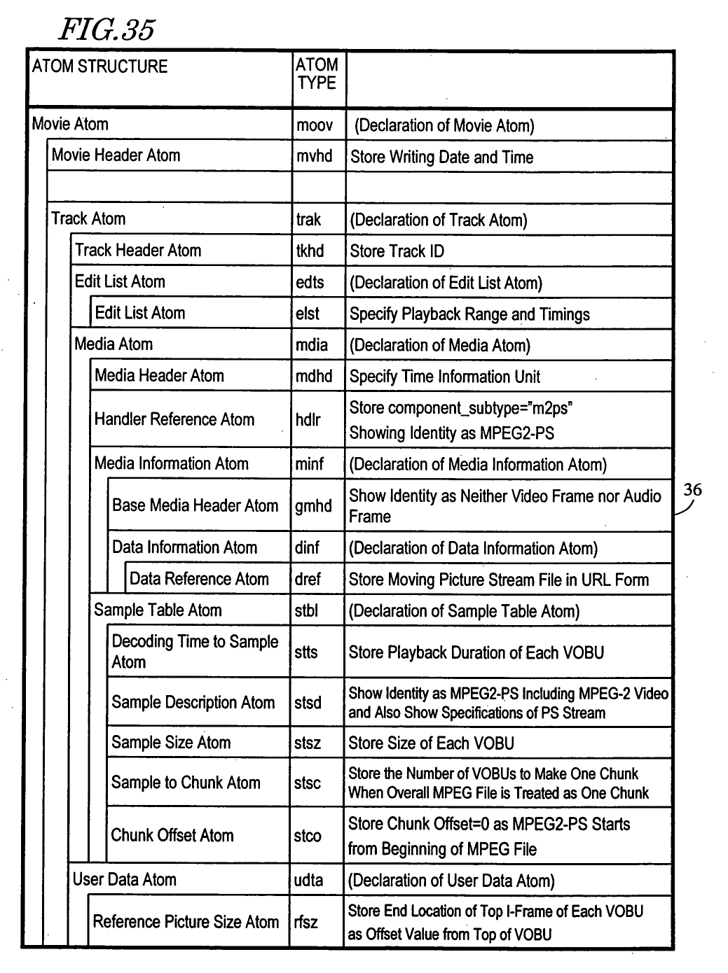

FIG. 34 shows the data structure of a QuickTime stream. The QuickTime stream also consists of a file (“MOV001.MOV”) describing the auxiliary information 13 and a PS file (“MOV001.MPG”) including the MPEG2-PS 14. Compared with the MP4 stream 12 shown in FIG. 15, “Movie Atom” defined by the auxiliary information 13 of the QuickTime stream is partially changed. Specifically, “Null Media Header Atom” is replaced with “Base Media Header Atom” 36 newly provided, and “Object Descriptor Atom” shown on the third row of FIG. 15 is deleted from the auxiliary information 13 shown in FIG. 34. FIG. 35 shows the contents of respective atoms in the auxiliary information 13 of the QuickTime stream. If the data of a sample (VOBU) is neither a video frame nor an audio frame, the “Base Media Header Atom” 36 added indicates that. The other atom structure shown in FIG. 35 and its contents are the same as those of the MP4 stream 12 described above and the description thereof will be omitted herein.

In the preferred embodiments of the present invention described above, the MPEG2-PS 14 shown in FIG. 12 is supposed to contain moving picture data (VOBU) for 0.4 second to 1 second. However, the time range may be different. Also, the MPEG2-PS 14 is supposed to consist of VOBUs compliant with the DVD Video recording standard. Alternatively, the MPEG2-PS 14 may also be a program stream compliant with the MPEG-2 system standard or a program stream compliant with the DVD Video standard.

In the data processor 10 shown in FIG. 11, the storage medium 131 is supposed to be a DVD-RAM disc. However, the storage medium is not particularly limited to a DVD-RAM. Examples of other preferred storage media 131 include optical storage media such as an MO, a DVD-R, a DVD-RW, a DVD+RW, a CD-R and a CD-RW and magnetic recording media such as a hard disk. As another alternative, the storage medium 131 may also be a semiconductor storage medium such as a semiconductor memory.

The data processor 10 performs the processing of generating, writing and reading a data stream according to a computer program. For example, the processing of generating and writing the data stream may be carried out by executing a computer program that is described based on the flowchart shown in FIG. 21. The computer program may be stored in any of various types of storage media. Examples of preferred storage media include optical storage media such as optical discs, semiconductor storage media such as an SD memory card and an EEPROM, and magnetic recording media such as a flexible disk. Instead of using such a storage medium, the computer program may also be downloaded via a telecommunications line (e.g., through the Internet, for example) and installed in the optical disc drive 100.

### INDUSTRIAL APPLICABILITY

According to the present invention, while the data structure of auxiliary information is adapted to the updated standard of today so as to comply with the ISO standard, a data structure for a data stream, having a format equivalent to a conventional one, and a data processor, operating on such a data structure, are provided as well. Since the data stream is compatible with the conventional format, any existent application can use the data stream. Consequently, every piece of existent software and hardware can be used effectively.

1. A data processor comprising:
a receiving section for receiving video data and audio data;
a compressing section for generating encoded data, complying with the MPEG-2 system standard, by encoding the video data and the audio data received;
an auxiliary information generating section for generating auxiliary information, which includes reference information to make reference to the encoded data and attribute information that uses a video object unit (VOBU) of the encoded data as a sample unit and that describes an attribute of the sample unit; and
a writing section for writing the encoded data and the auxiliary information on a storage medium as a data file and an auxiliary information file, respectively,
wherein the encoded data is decodable by either the auxiliary information file or the MPEG-2 system standard.

2. The data processor of claim 1, wherein the reference information represents the file name and storage location of the data file stored on the storage medium.

3. The data processor of claim 1, wherein the compressing section generates the encoded data as a plurality of sets, and
wherein the auxiliary information generating section generates the reference information that makes reference to each said set of encoded data.

4. The data processor of claim 1, wherein the compressing section generates the encoded data as a plurality of sets, and
wherein the auxiliary information generating section generates stream data as a single stream by arranging the plurality of sets of encoded data as a series, and also generates auxiliary information that further describes location information specifying the storage location of the encoded data if the data size of the encoded data is not constant every time the data is read.

5. The data processor of claim 1, wherein the compressing section generates the encoded data as either an MPEG-2 program stream or an MPEG-2 transport stream.

6. The data processor of claim 1, wherein the auxiliary information generating section describes an audio frame of encoded audio data, representing the audio data of the encoded data, as another sample unit in the attribute information.

7. The data processor of claim 3, wherein the compressing section generates first, second and third data files, the second data file including frame data that is needed to decode the encoded data of the first and third data files continuously with no time gap left.

8. The data processor of claim 1, wherein the auxiliary information generating section generates an auxiliary information file that is described in the MP4 format.

9. The data processor of claim 1, wherein the auxiliary information generating section generates an auxiliary information file that is described in the QuickTime format.

10. Stream data comprising: encoded data included in a data file; and auxiliary information included in an auxiliary information file,
wherein the encoded data is obtained by encoding video data and audio data in accordance with the MPEG-2 system standard, and is decodable by either the auxiliary information or the MPEG-2 system standard, and
wherein the auxiliary information includes: reference information to make reference to the encoded data; and attribute information that uses a video object unit (VOBU) of the encoded data as a sample unit and that describes an attribute of the sample unit.

11. A storage medium on which the stream data of claim 10 is stored.

12. A data processor comprising:
a reading section for reading the auxiliary information file from the stream data of claim 10 and also reading the data file in response to a control signal;
a reading control section for generating, as the control signal, a signal instructing that the data file be read in accordance with the reference information defined by the auxiliary information of the auxiliary information file;
a decoding section, which receives the encoded data from the data file read and the auxiliary information and which decodes the encoded data into the video data and the audio data in accordance with the attribute information included in the auxiliary information; and
an output section for outputting the video and audio data decoded.

13. A data writing method comprising steps of:
receiving video data and audio data;
generating encoded data, complying with the MPEG-2 system standard, by encoding the video data and audio data received;
generating auxiliary information, which includes reference information to make reference to the encoded data and attribute information that uses a video object unit (VOBU) of the encoded data as a sample unit and that describes an attribute of the sample unit; and
writing the encoded data and the auxiliary information on a storage medium as a data file and an auxiliary information file, respectively,
wherein the encoded data is decodable by either the auxiliary information file or the MPEG-2 system standard.

14. A computer program to be executed by a data processor, the program comprising steps of:
receiving video data and audio data;
generating encoded data, complying with the MPEG-2 system standard, by encoding the video data and audio data received;
generating auxiliary information, which includes reference information to make reference to the encoded data and attribute information that uses a video object unit (VOBU) of the encoded data as a sample unit and that describes an attribute of the sample unit; and
writing the encoded data and the auxiliary information on a storage medium as a data file and an auxiliary information file, respectively,
wherein the encoded data is decodable by either the auxiliary information file or the MPEG-2 system standard.

15. A data reading method comprising steps of:
reading the auxiliary information file from the stream data of claim 10;
generating a control signal instructing that the data file be read in accordance with the reference information defined by the auxiliary information of the auxiliary information file;
reading the data file in response to the control signal;
receiving the encoded data from the data file read and the auxiliary information and decoding the encoded data into the video data and the audio data in accordance with the attribute information included in the auxiliary information; and
outputting the video and audio data decoded.

16. A computer program to be executed by a data processor, the program comprising steps of:
reading the auxiliary information file from the stream data of claim 10;
generating a control signal instructing that the data file be read in accordance with the reference information defined by the auxiliary information of the auxiliary information file;
reading the data file in response to the control signal;
receiving the encoded data from the data file read and the auxiliary information and decoding the encoded data into the video data and the audio data in accordance with the attribute information included in the auxiliary information; and
outputting the video and audio data decoded.

17. A data processor comprising:
a receiving section for receiving video data and audio data;
a compressing section, which encodes the received video and audio data by a predetermined encoding technique, thereby generating encoded data in which data representing the video data and data representing the audio data are interleaved with each other; and
an auxiliary information generating section for generating auxiliary information, which includes reference information to make reference to the encoded data and attribute information that describes an attribute of a sample unit,
wherein the sample is a set of the encoded data that has been collected according to a playback duration of the video data, and
wherein the encoded data is decodable by either the auxiliary information or a decoding technique corresponding to the predetermined encoding technique.
